(19) United States
(12) Patent Application Publication
(10) Pub. No.: US 2026/0066981 A1
(43) Pub. Date: Mar. 5, 2026

(54) WIRELESS COMMUNICATION METHOD, TERMINAL DEVICE, AND NETWORK DEVICE

(71) Applicant: GUANGDONG OPPO MOBILE TELECOMMUNICATIONS CORP., LTD., Dongguan (CN)

(72) Inventor: Hao WANG, Dongguan (CN)

(21) Appl. No.: 19/383,353

(22) Filed: Nov. 7, 2025

Related U.S. Application Data
(63) Continuation of application No. PCT/CN2023/115051, filed on Aug. 25, 2023.

(51) Int. Cl. H04B 7/06; H04W 72/044

(52) U.S. Cl. CPC H04B 7/06964; H04B 7/0626; H04W 72/044

(57) ABSTRACT

A wireless communication method includes: receiving or transmitting, by a terminal device, first information for beam failure recovery through a first carrier, the first carrier being located in a frequency range (FR) 1.

### CROSS-REFERENCE TO RELATED APPLICATION

This application is a Continuation Application of International Application No. PCT/CN2023/115051 filed Aug. 25, 2023, which is incorporated herein by reference in its entirety.

### TECHNICAL FIELD

The present disclosure relates to the technical field of communications, and more specifically, to a wireless communication method, a terminal device and a network device.

### BACKGROUND

Currently, in order to improve the transmission rate of a sidelink system, it is considered that a millimeter-wave frequency band is used in the sidelink communication. In the sidelink millimeter-wave transmission system, a data transmission may be performed between terminal devices by using an analog beam. However, due to the high loss of the millimeter-wave frequency band and the relatively narrow coverage direction of the analog beam, the communication link is to be blocked easily, resulting in poor communication quality and even communication interruption. When the communication quality deteriorates to a certain extent, this is referred to as an occurrence of beam failure. In response to the beam failure occurring, a beam failure recovery operation is required, but a success ratio of the beam failure recovery is relatively low.

### SUMMARY

The present disclosure provides a wireless communication method, a terminal device, and a network device. Various aspects involved in the present disclosure are introduced below.

In a first aspect, a wireless communication method is provided, and includes: receiving or transmitting, by a terminal device, first information for beam failure recovery through a first carrier, the first carrier being located in a frequency range (FR) 1.

In a second aspect, a terminal device is provided, and includes: a transceiver, a memory and a processor, where the memory is configured to store a computer program, and the computer program, when executed by the processor, enables the terminal device to perform: receiving or transmitting first information for beam failure recovery through a first carrier, the first carrier being located in a frequency range (FR) 1.

In a third aspect, a network device is provided, and includes: a transceiver, a memory and a processor, where the memory is configured to store a computer program, and the computer program, when executed by the processor, enables the network device to perform: transmitting first configuration information to a terminal device, the first configuration information being used for configuring a sidelink resource for transmitting first information; where the first information is used for beam failure recovery, and a first carrier in which the sidelink resource of the first information is located is in a frequency range (FR) 1.

### BRIEF DESCRIPTION OF THE DRAWINGS

FIG. 1 is a wireless communication system 100 applied in the embodiments of the present disclosure.

FIG. 2 illustrates a frame structure of a system frame not carrying a physical sidelink feedback channel (PSFCH) in NR-V2X.

FIG. 3 illustrates a frame structure of a system frame carrying a PSFCH in NR-V2X.

FIG. 4 illustrates a communication process based on beam communication in a scenario where a network device communicates with a terminal.

FIG. 5 illustrates a communication process based on beam communication in a scenario where a network device communicates with a terminal.

FIG. 6 is a schematic flowchart of a wireless communication method in the embodiments of the present disclosure.

FIG. 7 is a schematic diagram of time-domain positions of CSI-RS resources in an embodiment of the present disclosure.

FIG. 8 is a schematic diagram of time-domain positions of CSI-RS resources in another embodiment of the present disclosure.

FIG. 9 is a schematic diagram of time-domain positions of CSI-RS resources in another embodiment of the present disclosure.

FIG. 10 is a schematic diagram of time-domain positions of CSI-RS resources in another embodiment of the present disclosure.

FIG. 11 is a schematic diagram of frequency-domain positions of CSI-RS resources in an embodiment of the present disclosure.

FIG. 12 is a schematic diagram of frequency-domain positions of CSI-RS resources in another embodiment of the present disclosure.

FIG. 13 is a schematic diagram of a terminal device in the embodiments of the present disclosure.

FIG. 14 is a schematic diagram of a network device in the embodiments of the present disclosure.

FIG. 15 is a schematic structural diagram of a communication apparatus in the embodiments of the present disclosure.

### DETAILED DESCRIPTION

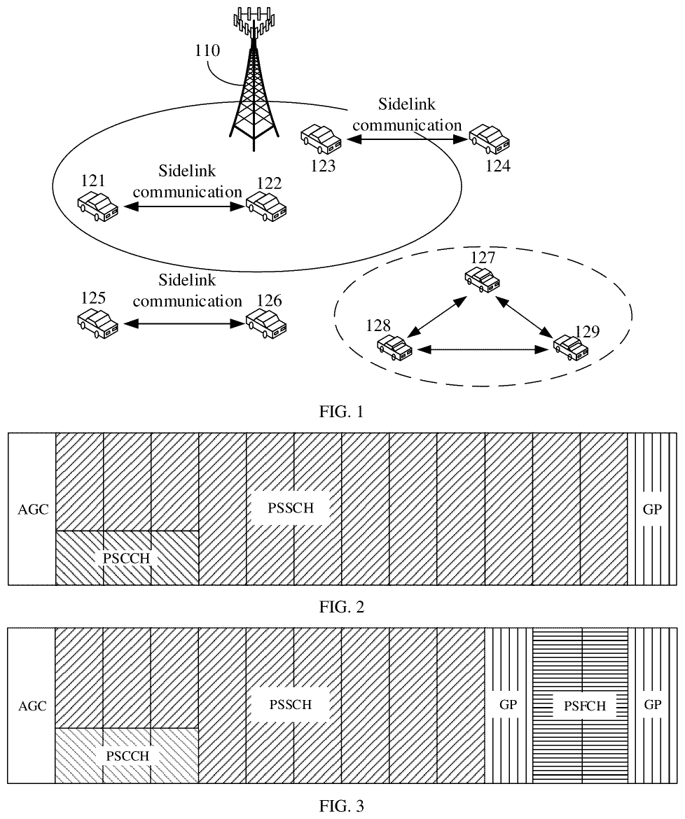

The technical solutions in the present disclosure will be described below with reference to the drawings. For ease of understanding, terms and communication processes involved in the present disclosure are first introduced below with reference to FIG. 1 to FIG. 5.

FIG. 1 is a wireless communication system 100 to which the embodiments of the present disclosure are applicable. The wireless communication system 100 may include a network device 110, and terminals 121 to 129. The network device 110 may provide communication coverage for a certain geographical area and may communicate with a terminal located within the coverage area.

In some implementations, a terminal may communicate with a terminal through a sidelink (SL). Sidelink communication may also be referred to as proximity services (ProSe) communication, unilateral communication, side-link communication, or device to device (D2D) communication.

In other words, sidelink data is transmitted between a terminal and a terminal through the sidelink. Here, the sidelink data may include data and/or control signaling. In some implementations, the sidelink data may be, for example, a physical sidelink control channel (PSCCH), a physical sidelink shared control channel (PSSCH), a PSCCH demodulation reference signal (DMRS), a PSSCH DMRS, a physical sidelink feedback channel (PSFCH), or the like.

Some common sidelink communication scenarios are introduced below with reference to FIG. 1. Depending on whether the terminal in the sidelink is located within the coverage range of the network device, the sidelink communication is classified into three scenarios. In a scenario 1, the terminals perform the sidelink communication within the coverage range of the network device. In a scenario 2, some of the terminals perform the sidelink communication within the coverage range of the network device. In a scenario 3: the terminals perform the sidelink communication outside the coverage range of the network device.

As illustrated in FIG. 1, in the scenario 1, a terminal 121 and a terminal 122 may perform communication through the sidelink, and the terminal 121 and the terminal 122 are all within the coverage range of network device 110; or in other words, the terminal 121 the terminal 122 are all within the coverage range of the same network device 110. In this scenario, the network device 110 may transmit configuration signaling to the terminal 121 and the terminal 122, and accordingly, the terminal 121 and the terminal 122 perform communication through the sidelink based on the configuration signaling.

As illustrated in FIG. 1, in the scenario 2, a terminal 123 and a terminal 124 may perform communication through the sidelink, and the terminal 123 is within the coverage range of the network device 110, while the terminal 124 is outside the coverage range of the network device 110. In this scenario, the terminal 123 receives configuration information from the network device 110 and performs communication through the sidelink based on the configuration of the configuration signaling. However, for the terminal 124, the terminal 124 fails to receive configuration information of the network device 110 as it is outside the coverage range of the network device 110. In this case, the terminal 124 may acquire a configuration of the sidelink communication, based on configuration information according to a pre-configuration and/or configuration information transmitted from the terminal 123 within the coverage range, so as to perform communication with the terminal 123 through the sidelink based on the acquired configuration.

In some cases, the terminal 123 may transmit the above-mentioned configuration information to the terminal 124 through a physical sidelink broadcast channel (PSBCH), so as to configure the terminal 124 to perform communication through the sidelink.

As illustrated in FIG. 1, in the scenario 3, a terminal 125 to a terminal 129 are all outside the coverage range of the network device 110, and fail to perform communication with the network device 110. In this case, the terminals may configure the sidelink communication based on pre-configuration information.

In some cases, the terminal 127 to the terminal 129 that are outside the coverage range of the network device may constitute a communication group, and the terminal 127 to the terminal 129 in the communication group may perform communication with each other. In addition, the terminal 127 in the communication group may serve as a central control node, which is also referred to as a cluster header (CH), and accordingly, other terminals in the communication group may be referred to as “group members”.

The terminal 127 serving as the CH may have one or more of the following functions: responsible for establishing the communication group; responsible for joining and leaving of the group member; coordinating resources, allocating sidelink transmission resources to the group members, and receiving sidelink feedback information from the group members; and coordinating resources with other communication groups; or the like.

It should be noted that FIG. 1 exemplarily illustrates a network device and multiple terminal devices. Optionally, the wireless communication system 100 may include multiple network devices and other number of terminal devices may be included within the coverage range of each of the network devices, which is not limited in the embodiments of the present disclosure.

Optionally, the wireless communication system 100 may also include other network entities such as a network controller, a mobility management entity, which is not limited in the embodiments of the present disclosure.

It should be understood that the technical solutions of the embodiments of the present disclosure may be applied to various communication systems, such as: a 5th generation (5G) system, or a new radio (NR), long term evolution (LTE) system, an LTE frequency division duplex (FDD) system, an LTE time division duplex (TDD) system. The technical solutions provided by the present disclosure may also be applied to a future communication system, such as a 6th generation mobile communication system, a satellite communication system.

The terminal in the embodiments of the present disclosure may also be referred to as a user equipment (UE), an access terminal, a user unit, a user station, a mobile platform, a mobile station (MS), a mobile terminal (MT), a remote station, a remote terminal, a mobile device, a user terminal, a terminal device, a wireless communication device, a user agent or a user apparatus. The terminal device in the embodiments of the present disclosure may refer to a device that provides voice and/or data connectivity to a user and may be used to connect people, objects, and machines, such as a handheld device or vehicle-mounted device with a wireless connection function. The terminal device in the embodiments of the present disclosure may be a mobile phone, a pad, a laptop computer, a handheld computer, a mobile Internet device (MID), a wearable device, a virtual reality (VR) device, an augmented reality (AR) device, a wireless terminal in industrial control, a wireless terminal in self driving, a wireless terminal in remote medical surgery, a wireless terminal in a smart grid, a wireless terminal in transportation safety, a wireless terminal in a smart city, a wireless terminal in a smart home, etc. Optionally, the UE may be used to act as a base station. For example, the UE may act as a scheduling entity, providing sidelink data between UEs in V2X or D2D, or the like. For example, a cellular phone and a car communicate with each other by using the sidelink data. The cellular phone and a smart home device communicate with each other without relaying the communication signal via a base station.

The network device in the embodiments of the present disclosure may be a device for communicating with the terminal device, and the network device may also be referred to as an access network device or a wireless access network device, e.g., the network device may be a base station. The network device in the embodiments of the present disclosure may refer to a radio access network (RAN) node (or device) that accesses the terminal device to a wireless network. The base station may broadly cover the following various names, or be replaced with the following names, such as: node B (NodeB), evolved base station (evolved NodeB, eNB), next generation base station next generation NodeB, gNB), relay station, access point (AP), transmission point (transmitting and receiving point, TRP), transmitting point (TP), master station MeNB, secondary station SeNB, multi-standard radio (MSR) node, home base station, network controller, access node, wireless node, access point (AP), transmission node, transceiver node, base band unit (BBU), remote radio unit (RRU), active antenna unit (AAU), remote radio head (RRH), central unit (CU), distributed unit (DU), positioning node, or the like. The base station may be a macro base station, a micro base station, a relay node, a donor node, or the like, or a combination thereof. The base station may also refer to a communication module, a modem or a chip for being set within the above device or apparatus. The base station may also be a mobile switching center, and a device that undertakes a base station function in device-to-device D2D, vehicle-to-everything (V2X), machine-to-machine (M2M) communications, a network-side device in a 6G network, a device that undertakes a base station function in future communication systems, or the like. The base station may support networks with the same or different access technologies. The embodiments of the present disclosure do not limit the specific technology and the specific device form used for the network device.

The base station may be fixed or mobile. For example, a helicopter or drone may be configured to act as a mobile base station, and one or more cells may be moved according to the position of the mobile base station. In other examples, the helicopter or drone may be configured to be used as a device for communicating with another base station.

In some deployments, the network device in the embodiments of the present disclosure may refer to a CU or a DU, or, the network device includes a CU and a DU. The gNB may also include an AAU.

The network device and the terminal device may be deployed on land, including indoor or outdoor, handheld or in-vehicle; or deployed on water; or deployed on airborne aircrafts, balloons, and satellites. The scenarios in which the network device and the terminal device are located are not limited in the embodiments of the present disclosure.

It should be understood that all or some of functions of the communication device in the present disclosure may also be implemented through a software function running on hardware, or implemented through a virtualized function instantiated on a platform (e.g., a cloud platform).

### Sidelink Communication Mode

Some standards or protocols (e.g., third Generation Partnership Project (3GPP)) define two modes of sidelink communication: a first mode and a second mode.

In the first mode, a resource of the terminal device (the resource mentioned in the present disclosure may also be referred to as a transmission resource, e.g., a time-frequency resource) is allocated by the network device. The terminal device may transmit data on the sidelink according to the resource allocated by the network device. The network device may allocate a resource for a single transmission to the terminal device, or may also allocate a resource for a semi-static transmission to the terminal device. The first mode may be applied to a scenario with the coverage of the network device, e.g., the scenario illustrated in FIG. 1 above. In the scenario illustrated in FIG. 1, the terminal device 123 is located within the network coverage range of the network device 110, and thus the network device 110 may allocate a resource used in the sidelink transmission process to the terminal device 123.

In the second mode, the terminal device may autonomously select one or more resources from a resource pool (RP). Then, the terminal device may perform sidelink transmission according to the selected resource. For example, in the scenario illustrated in FIG. 1, the terminal device 124 is located outside the coverage range of the cell. Therefore, the terminal device 124 may autonomously select a resource for sidelink transmission from a preconfigured resource pool. Alternatively, in the scenario illustrated in FIG. 1, the terminal device 124 may also autonomously select one or more resources for sidelink transmission from a resource pool configured by the network device 110.

### Sidelink Transmission Mode

With the development of the autonomous driving technology, the autonomous driving technology may be integrated with the communication system, or in other words, data interaction between vehicle-mounted devices needs to be implemented through the communication system. Therefore, higher requirements are placed on the communication system. For example, the communication system is required to support a higher throughput, a lower latency, higher reliability, a larger coverage range, more flexible resource allocation, or the like. In LTE-V2X, the sidelink communication is supported between a terminal and a terminal only in a broadcast mode. With the development of technologies, unicast and multicast transmission modes are introduced in NR-V2X.

For the unicast transmission mode, there is usually only one terminal that receives sidelink data. Referring to FIG. 1, the terminal 121 and the terminal 122 may perform communication with each other in the unicast transmission mode. When the terminal 121 transmits sidelink data via the sidelink, the terminal 122 receives the sidelink data as the only receiving device.

For the multicast transmission mode, terminals receiving the sidelink data may be all terminals in a communication group, or terminals receiving the sidelink data may be all terminals within a certain transmission distance. For example, referring to FIG. 1, for the communication group including the terminal 127 to the terminal 129, when the terminal 127 transmits the sidelink data in the multicast mode, the terminal 128 and the terminal 129 in the communication group are all receiving terminals that receive the sidelink data. For another example, referring to FIG. 1, assuming that terminals within a preset range include the terminal 127 to the terminal 129, when the terminal 127 transmits the sidelink data in the multicast mode, the terminal 128 and the terminal 129 within the preset range are all receiving terminals that receive the sidelink data.

For the broadcast transmission mode, the terminal receiving the sidelink data may be any terminal around the terminal serving as a transmitting end. For example, referring to FIG. 1, assuming that the terminal 125 serves as the transmitting end and transmits the sidelink data in the broadcast mode, the terminals 121 to 124 and the terminals 126 to 129 located around the terminal 125 may all serve as receiving ends of the sidelink data.

### System Frame Structure

The frame structure of the sidelink system frame applicable to the embodiments of the present disclosure is introduced below with reference to FIG. 2 and FIG. 3. FIG. 2 illustrates a frame structure of a system frame not carrying a PSFCH in NR-V2X. FIG. 3 illustrates a frame structure of a system frame carrying a PSFCH in NR-V2X.

Referring to FIG. 2, in the time domain, sidelink symbols occupied by a PSCCH, which start from a second sidelink symbol (e.g., orthogonal frequency division multiplexing (OFDM) symbol (referred to as “symbol” for simplicity)) of the system frame, occupy 2 or 3 sidelink symbols. In the frequency domain, the PSCCH may occupy {10, 12, 15, 20, 25} physical resource blocks (PRBs). Generally, in order to reduce the complexity of the terminal device performing blind detection on the PSCCH, only one certain number of symbols and one certain number of PRBs is allowed to be configured for the PSCCH in a resource pool. In addition, since a subchannel is the minimum granularity for PSSCH resource allocation specified in NR-V2X, the number of PRBs occupied by the PSCCH must be less than or equal to the number of PRBs included in a subchannel in the resource pool, so as to avoid additional restrictions on PSSCH resource selection or allocation.

Continuing to refer to FIG. 2, in the time domain, the PSSCH also starts from a second sidelink symbol of the system frame and ends at a second last sidelink symbol of the system frame. In the frequency domain, the PSSCH occupies K subchannels of the system frame, and each of the subchannels includes N continuous PRBs, where K and N are positive integers.

Generally, the last symbol of the system frame is a guard period (GP) symbol. In addition, the first sidelink symbol of the system frame is a repetition of the second sidelink symbol. Generally, the terminal may use the first sidelink symbol as an automatic gain control (AGC) symbol when receiving the system frame, and data on the AGC symbol is generally not used for data demodulation.

Referring to FIG. 3, when the system frame carries a PSFCH channel, a second last sidelink symbol and a third last sidelink symbol in the system frame are used for the PSFCH transmission. In addition, a sidelink symbol before the sidelink symbols carrying the PSFCH in the system frame serves as a GP.

### Multi-Beam System

The design goal of the communication system (e.g., NR) includes large-bandwidth communication in a high-frequency band (e.g., a frequency band above 6 GHZ). When the operating frequency becomes higher, the path loss in the transmission process will increase, thereby affecting the coverage capability of the high-frequency system. Therefore, in order to effectively ensure the coverage range of the high-frequency band, an effective technical solution is to form beamforming having a greater gain based on a massive antenna array (Massive multiple-in multiple-out, Massive MIMO), so as to overcome the propagation loss, and ensure the coverage range of the communication system.

Currently, the common massive antenna array is the millimeter-wave antenna array. Since the wavelength emitted by the millimeter-wave antenna array is relatively short, the interval between antenna elements of the antenna array may be relatively short and the aperture of the antenna element may be relatively small, so that more physical antenna elements may be integrated into a two-dimensional antenna array with a limited size.

In addition, since the size of the millimeter-wave antenna array is limited, digital beamforming cannot be used considering factors such as hardware complexity, cost overhead, and power consumption. Instead, analog beamforming is usually used, which may enhance the network coverage and meanwhile reduce the implementation complexity of the device.

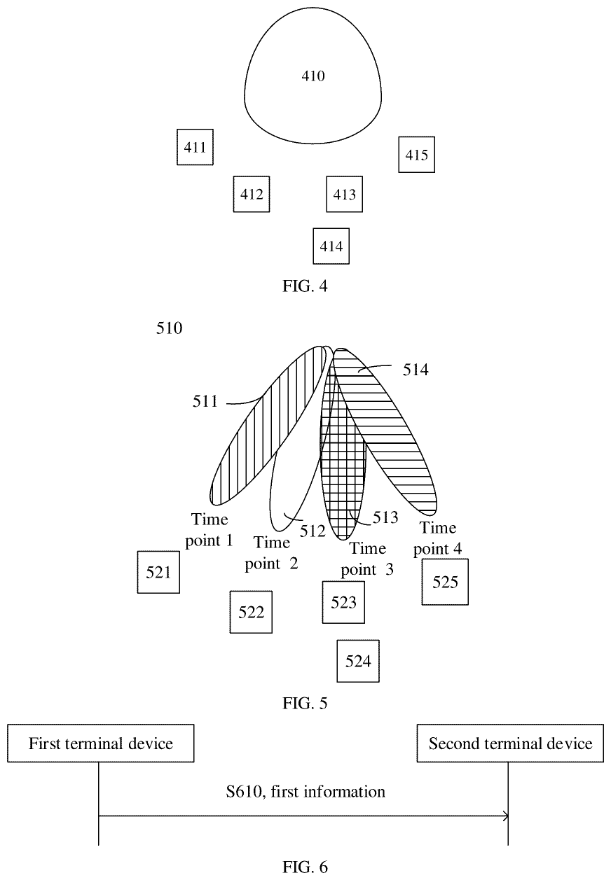

For ease of understanding of the multi-beam system, the communication process based on beam communication is introduced below with reference to FIG. 4 and FIG. 5, by taking a scenario where a network device communicates with a terminal as an example.

Referring to FIG. 4, in a traditional communication system (e.g., a 2G, 3G, or 4G communication system), a relatively wide beam 410 is generally used to cover an entire cell (or referred to as a “sector”). In this way, terminals within the cell (e.g., a terminal 411 to a terminal 415) may communicate with the network device via this relatively wide beam at each time point, for example, to acquire transmission resources allocated by the network device.

Referring to FIG. 5, in a newer communication system (e.g., NR), a multi-beam system 510 may be used to cover the entire cell. That is, each beam (e.g., a beam 511 to a beam 514) in the multi-beam system covers a smaller range in the cell, respectively, and the effect of the multiple beams covering the entire cell is achieved by means of beam sweeping.

In the process of beam sweeping, different beams are used at different time points to cover different areas in the cell. For example, at a time point 1, the communication system may cover an area in which the terminal 521 is located via a beam 511. At a time point 2, the communication system may cover an area in which the terminal 522 is located via a beam 512. At a time point 3, the communication system may cover an area in which the terminal 523 and the terminal 524 are located via a beam 513. At a time point 4, the communication system may cover an area in which the terminal 525 is located via a beam 514.

For the multi-beam system, since relatively narrow beams are used, the transmission energy may be more concentrated, and thus a farther distance may be covered. However, precisely because the beams are relatively narrow, each of the beams can only cover a partial area in the cell, and thus, the multi-beam system may be understood as “trading time for space.”

Generally, a beam for the transmitting end to transmit a signal is referred to as a “transmit beam”. A beam for the receiving end to receive a signal is referred to as a “receive beam”.

In some cases, the above-mentioned transmit beam may also be referred to as a spatial domain transmission filter, and accordingly, the above-mentioned receive beam may also be referred to as a spatial domain reception filter. In other cases, the above-mentioned beam may be referred to as a spatial domain transmission filter, and accordingly, transmitting the signal through the transmit beam may be described as transmitting the signal based on the spatial domain transmission filter, or sending the signal based on the spatial domain transmission filter; and receiving the signal through the receive beam may be described as receiving the signal based on the spatial domain transmission filter. In other cases, the above-mentioned transmit beam may also be referred to as a spatial domain transmission parameter, and accordingly, the above-mentioned receive beam may also be referred to as a spatial domain reception parameter.

### Beam Failure Recovery

In some scenarios, the beam failure recovery process may be briefly summarized as Step 1 to Step 4. It should be understood that the beam failure recovery procedure is introduced below in conjunction with the transmitting end and the receiving end, where the transmitting end may be understood as the transmitting end of the sidelink transmission, and the receiving end may be the receiving end of the sidelink transmission. Therefore, the transmitting end may also be referred to as a transmitting terminal, and the receiving end may also be referred to as a receiving terminal.

In Step 1, the transmitting end and/or the receiving end determines that beam failure has occurred.

In Step 2, the transmitting end transmits a (channel state information reference signal) CSI-RS by using a different beam or a same beam.

In Step 3, the receiving end performs measurement on a CSI-RS resource transmitted from the transmitting end, according to CSI-RS resource configuration information, selects a relatively optimal transmit beam according to a measurement result, and reports the corresponding CSI-RS resource to the transmitting end.

In Step 4, the transmitting end receives CSI-RS resource indication information reported by the receiving end, feeds back to the receiving end that beam failure recovery is successful, and indicates a transmit beam for a next transmission.

Currently, in order to improve the transmission rate of the sidelink system, it is considered that the millimeter-wave frequency band is used in the sidelink communication. In the sidelink millimeter-wave transmission system, a data transmission may be performed between terminal devices by using an analog beam. However, due to the high loss of the millimeter-wave frequency band and the relatively narrow coverage direction of the analog beam, the communication link is to be blocked easily, resulting in poor communication quality and even communication interruption. When the communication quality deteriorates to a certain extent, this is referred to as an occurrence of beam failure.

In a case where the beam failure occurs, the beam failure recovery operation requires to be performed, for example, reselecting a transmit beam and/or a receive beam. However, considering that the loss of the millimeter-wave frequency band (FR2) communication is severe, in this case, it may be impossible to successfully complete the beam failure recovery still through the FR2.

Therefore, regarding the above-mentioned problems, the embodiments of the present disclosure provide a wireless communication method in which the terminal device may transmit or receive first information for beam failure recovery through other frequency band other than the FR2, which helps to increase the possibility of beam failure recovery, as compared with the traditional solutions in which the information for beam failure recovery is still transmitted through the FR2.

In some implementations, the above-mentioned other frequency band may be, for example, an FR1, where the FRI is also referred to as sub-6 GHZ, and this frequency band may cover a frequency range between 410 MHz and 7125 MHz. Accordingly, if the terminal device supports the carrier aggregation technology for the FRI and the FR2 (also referred to as “FR1+FR2”) or the terminal device supports the cross-band carrier aggregation technology, the terminal device may transmit the information for beam failure recovery (also referred to as “first information”) through the FR1.

The wireless communication method in the embodiments of the present disclosure is introduced below with reference to FIG. 6, and the wireless communication method illustrated in FIG. 6 includes Step S610.

In Step S610, a first terminal device transmits first information for beam failure recovery to a second terminal device; or in other words, a terminal device receives or transmits the first information for beam failure recovery through a first carrier. In this case, if a terminal device performs the receiving operation, this terminal device is the second terminal device. If a terminal device performs the transmitting operation, this terminal device may be the first terminal device.

In some implementations, the first terminal device may be the transmitting end of the sidelink transmission, and accordingly, the second terminal device may be the receiving end of the sidelink transmission. In other implementations, the first terminal device may be the receiving end of the sidelink transmission, and accordingly, the second terminal device may be the transmitting end of the sidelink transmission. For ease of description, a description is made below by taking the transmitting end of the sidelink transmission (referred to as the transmitting end for simplicity) and the receiving end of the sidelink transmission (referred to as the receiving end for simplicity) as an example.

In some implementations, the first carrier may be a carrier different from a second carrier, and the second carrier may be a carrier on which beam failure occurs. For example, the first carrier may be a carrier located in the FRI, and accordingly, the second carrier may be a carrier located in the FR2.

In some implementations, the first information is used for beam failure recovery; or in other words, the first information is used for assisting beam failure recovery.

In some implementations, the first information may carry one or more of: first indication information; second indication information; information of a first transmit beam; CSI-RS resource configuration information; first CSI-RS resource information; a first measurement result corresponding to the first CSI-RS resource information; beam failure recovery information; and second CSI-RS resource information. The first information in the embodiments of the present disclosure is introduced below in conjunction with Example 1 to Example 8.

### Example 1: The First Information Includes the First Indication Information

In some implementations, the first indication information is used for indicating that the beam failure occurs, and thus, in the embodiments of the present disclosure, the first indication information may also be referred to as “beam failure indication information.”

Generally, the occurrence of the beam failure may be determined by the transmitting end, or the occurrence of the beam failure may be determined by the receiving end. Regardless of whether it is determined by the transmitting end or the receiving end, the device determining the occurrence of the beam failure may transmit the first indication information to the opposite device, so as to indicate that the beam failure occurs, so that the two devices start a subsequent beam failure recovery process.

In some implementations, the first indication information may occupy 1 bit, which helps reduce the overhead of transmitting the first indication information. In some implementations, the value of this bit may be a first value, which is used for indicating that the beam failure occurs. Accordingly, if the value of this bit is a second value, it is used for indicating that no beam failure occurs. The first value and the second value may be different values. For example, the first value may be 1, and accordingly, the second value may be 0. For another example, the first value may be 0, and accordingly, the second value may be 1. Certainly, in the embodiments of the present disclosure, the first indication information may also occupy multiple bits.

In some implementations, the above-mentioned first indication information may be carried by one or more of: sidelink control information (SCI); a media access control element (MAC CE); and PC5-radio resource control (PC5-RRC) signaling. In other implementations, a priority of the first indication information may be set to the highest priority, which helps to prioritize the transmission of the first indication information, so as to proceed to the beam recovery procedure as quickly as possible. For example, in a case where the first indication information is carried by the SCI, a value of the priority of the SCI may be set to the highest priority. For another example, in a case where the first indication information is carried by the MAC CE, the priority of the MAC CE may be set to the highest priority.

In the embodiments of the present disclosure, the above-mentioned priority of the first indication information may be determined based on pre-configuration information or information configured by a network.

### Example 2: The First Information Includes the Second Indication Information

In some implementations, the second indication information may be used for indicating a switch to a first transmit beam; or in other words, the second indication information may be used for indicating the transmitting end to switch to the first transmit beam; or the second indication information may be used for indicating the transmitting end to perform communication with the receiving end by using the first transmit beam.

In some implementations, the above-mentioned first transmit beam may be one of candidate transmit beams. Accordingly, the candidate transmit beams may include one or more transmit beams.

For example, in a case where the transmitting end of a sidelink signal determines that the beam failure occurs and there are candidate transmit beam(s) on the transmitting end, the transmitting end may switch the current transmit beam to one of the candidate transmit beams, i.e., the first transmit beam. In this case, the transmitting end may transmit the second indication information to the receiving end, to indicate the switch to the first transmit beam.

In some implementations, the second indication information may occupy 1 bit, which helps reduce the overhead of transmitting the second indication information. In some implementations, the value of this bit may be a first value, which is used for indicating the switch to the first transmit beam. Accordingly, if the value of this bit is a second value, it is used for indicating no switch to the first transmit beam, or indicating that beam switching does not occur. The first value and the second value may be different values. For example, the first value may be 1, and accordingly, the second value may be 0. For another example, the first value may be 0, and accordingly, the second value may be 1. Certainly, in the embodiments of the present disclosure, the second indication information may also occupy multiple bits.

As mentioned above, the candidate transmit beams may include multiple transmit beams, and accordingly, the first transmit beam may be selected by the transmitting end from the candidate transmit beams. The method for selecting the first transmit beam is not limited in the embodiments of the present disclosure. In some implementations, the transmitting end may randomly select the first transmit beam from the candidate transmit beams. In other implementations, the transmitting end may perform the selection based on measurement results corresponding to different transmit beams among the candidate beams. For example, the transmitting end may select a transmit beam corresponding to a maximum measurement result as the first transmit beam.

The measurement result is not limited in the embodiments of the present disclosure. For example, the measurement result may be a measurement result of a layer 1. For another example, the measurement result may be a measurement result of a layer 3. For another example, the measurement result may include a reference signal receiving power (RSRP). For another example, the measurement result may include reference signal receiving quality (RSRQ).

In some implementations, the above-mentioned second indication information may be carried by one or more of: SCI; an MAC CE; and PC5-RRC. In other implementations, the priority of the second indication information may be set to the highest priority, which helps to prioritize the transmission of the second indication information. For example, in a case where the second indication information is carried by the SCI, the value of the priority of the SCI may be set to the highest priority. For another example, in a case where the second indication information is carried by the MAC CE, the priority of the MAC CE may be set to the highest priority.

In the embodiments of the present disclosure, the above-mentioned priority of the second indication information may be determined based on pre-configuration information or information configured by a network.

### Example 3: The First Information Includes the Information of the First Transmit Beam

In some implementations, it can be known from the above introduction that the first transmit beam may be one of the candidate transmit beams, and therefore, the information of the first transmit beam may also be referred to as information of a candidate transmit beam.

In some implementations, the above-mentioned information of the first transmit beam may include indication information of the first transmit beam. For example, the indication information of the first transmit beam may include a reference signal resource identifier corresponding to the first transmit beam. Taking an example in which the reference signal is a CSI-RS, the indication information of the first transmit beam may be a CSI-RS resource identifier corresponding to the first transmit beam. For another example, the indication information of the first transmit beam may include transmission configuration indicator state (TCI state) information associated with the first transmit beam.

In some implementations, the second indication information may be transmitted simultaneously with the information of the first transmit beam, and certainly, the second indication information may be transmitted separately from the information of the first transmit beam.

If the second indication information can be transmitted simultaneously with the information of the first transmit beam, in some scenarios, the second indication information may be indirectly indicated by the information of the first transmit beam, thereby helping to reduce the overhead of transmitting the second indication information and the information of the first transmit beam. That is, the second indication information may be omitted, and in this case, only the information of the first transmit beam may be transmitted, and in response to the receiving end receiving the information of the first transmit beam, the receiving end may determine that the transmitting end performs the beam switching and switches to the first transmit beam. Certainly, in the embodiments of the present disclosure, the second indication information and the information of first transmit beam may be two separate indication information.

In some implementations, the above-mentioned information of the first transmit beam may be carried by one or more of: SCI; an MAC CE; and PC5-RRC. In other implementations, the priority of the information of the first transmit beam may be set to the highest priority, which helps to prioritize the transmission of the information of the first transmit beam. For example, in a case where the information of the first transmit beam is carried by the SCI, the value of the priority of the SCI may be set to the highest priority. For another example, in a case where the information of the first transmit beam is carried by the MAC CE, the priority of the MAC CE may be set to the highest priority.

In the embodiments of the present disclosure, the above-mentioned priority of the information of the first transmit beam may be determined based on pre-configuration information or information configured by a network.

### Example 4: The First Information Includes the CSI-RS Resource Configuration Information

In some implementations, the CSI-RS resource configuration information is used for reselecting a transmit beam and/or a receive beam; or in other words, CSI-RS resource(s) configured by the CSI-RS resource configuration information are used for reselecting the transmit beam and/or the receive beam. In some scenarios, the CSI-RS resource configuration information may also be referred to as CSI-RS resource allocation information.

Generally, after the transmitting end determines that the beam failure occurs or the beam failure indication information (i.e., the first indication information mentioned above) transmitted from the receiving end is received, the transmitting end may transmit the CSI-RS resource configuration information, to indicate transmission resources occupied by the CSI-RS to be transmitted by the receiving end, where the CSI-RS to be transmitted is used for reselecting the transmit beam and/or the receive beam. Accordingly, after receiving the CSI-RS resource configuration information, the receiving end may perform measurement on the CSI-RS on the transmission resources indicated by the CSI-RS resource configuration information, to obtain measurement results, select a relatively optimal transmit beam based on the measurement results, and report the relatively optimal transmit beam information to the transmitting end.

In some implementations, the CSI-RS resource configuration information is used for configuring one or more of: a time-domain resource position of the CSI-RS resource; a frequency-domain resource position of the CSI-RS resource; and a transmit beam associated with the CSI-RS resource. The CSI-RS resource configuration information in the embodiments of the present disclosure is introduced below in conjunction with Example 4-1 to Example 4-3.

### Example 4-1: The CSI-RS Resource Configuration Information is Used for Configuring the Time-Domain Resource Position of the CSI-RS Resource

In some implementations, in a case where the CSI-RS resource configuration information is used for configuring the time-domain resource position of the CSI-RS resource, the time-domain resource position is periodically distributed or aperiodically distributed. That is, the CSI-RS resource(s) configured by the CSI-RS resource configuration information are periodically or aperiodically distributed in the time domain.

In some implementations, the CSI-RS resource configuration information is used for configuring one or more of: a time-domain offset of the CSI-RS resource; a time-domain interval between two adjacent CSI-RS resources within each period; a number of time-domain resources capable of being occupied by the CSI-RS resource within each period; a number of periodic transmissions of the CSI-RS resource; a time-domain interval between two CSI-RS resources adjacent in the time domain; a number of time-domain resources capable of being occupied by the CSI-RS resource; a period of the CSI-RS resource; and indication information of a time-domain resource occupied by the CSI-RS resource.

Taking an example in which the CSI-RS resource configuration information is used for configuring the time-domain offset of the CSI-RS resource, in some implementations, the time-domain offset of the CSI-RS resource may be used for indicating a time-domain offset between a time-domain resource occupied by the CSI-RS resource and a reference time-domain resource.

In some implementations, the time-domain resource occupied by the CSI-RS resource may be one of: a start position of the time-domain resource occupied by the CSI-RS resource, an end position of the time-domain resource occupied by the CSI-RS resource, and a center time-domain position of the time-domain resource occupied by the CSI-RS resource. In other implementations, the reference time-domain resource may be one of: a start position of the reference time-domain resource, an end position of the reference time-domain position, or a center time-domain position of the reference time-domain position.

In the embodiments of the present disclosure, the CSI-RS resource in the time-domain resource occupied by the CSI-RS resource mentioned above may be understood as a first CSI-RS resource among multiple CSI-RS resources; or in other words, may be a time-domain position corresponding to a CSI-RS resource closest to the reference time-domain resource. Certainly, in the embodiments of the present disclosure, the above-mentioned CSI-RS resource may also be any one CSI-RS resource of multiple CSI-RS resources. For example, it may be a last CSI-RS resource among the multiple CSI-RS resources; or in other words, it may be a time-domain position corresponding to a CSI-RS resource farthest from the reference time-domain resource.

Accordingly, the above-mentioned time-domain offset of the CSI-RS resource may be a time-domain offset between the start position of the time-domain resource occupied by the CSI-RS resource and the start position of the reference time-domain resource. Alternatively, the above-mentioned time-domain offset of the CSI-RS resource may be a time-domain offset between the start position of the time-domain resource occupied by the CSI-RS resource and the end position of the reference time-domain resource. Alternatively, the above-mentioned time-domain offset of the CSI-RS resource may be a time-domain offset between the start position of the time-domain resource occupied by the CSI-RS resource and the center time-domain position of the reference time-domain resource. The above-mentioned time-domain offset of the CSI-RS resource may be a time-domain offset between the end position of the time-domain resource occupied by the CSI-RS resource and the end position of the reference time-domain resource. Alternatively, the above-mentioned time-domain offset of the CSI-RS resource may be a time-domain offset between the end position of the time-domain resource occupied by the CSI-RS resource and the start position of the reference time-domain resource. Alternatively, the above-mentioned time-domain offset of the CSI-RS resource may be a time-domain offset between the end position of the time-domain resource occupied by the CSI-RS resource and the center time-domain position of the reference time-domain resource. The above-mentioned time-domain offset of the CSI-RS resource may be a time-domain offset between the center time-domain position of the time-domain resource occupied by the CSI-RS resource and the end position of the reference time-domain resource. Alternatively, the above-mentioned time-domain offset of the CSI-RS resource may be a time-domain offset between the center time-domain position of the time-domain resource occupied by the CSI-RS resource and the start position of the reference time-domain resource. Alternatively, the above-mentioned time-domain offset of the CSI-RS resource may be a time-domain offset between the center time-domain position of the time-domain resource occupied by the CSI-RS resource and the center time-domain position of the reference time-domain resource.

In some implementations, the time-domain resource may be a slot, a symbol or any other time-domain resource. Taking the slot as an example, the above-mentioned time-domain offset of the CSI-RS resource may refer to a time-domain offset between a slot occupied by the CSI-RS and a reference slot, and therefore, the time-domain offset may be referred to as a slot offset. Taking the symbol as an example, the above-mentioned time-domain offset of the CSI-RS resource may refer to a time-domain offset between a symbol occupied by the CSI-RS and a reference symbol, and therefore, the time-domain offset may be referred to as a symbol offset.

The reference time-domain resource is not limited in the embodiments of the present disclosure. For example, the reference time-domain resource may be determined based on a time-domain position associated with the CSI-RS resource configuration information. In some implementations, the CSI-RS resource configuration information and the reference time-domain resource may be located in a same slot; or in other words, a slot in which the reference time-domain resource is located may be the same as a slot in which the CSI-RS resource configuration information is located. In other implementations, the time-domain position associated with the CSI-RS resource configuration information may be a time-domain position of the time-domain resource occupied by the CSI-RS resource configuration information, where the time-domain position of the time-domain resource occupied by the CSI-RS resource configuration information may be one of a time-domain start position, a time-domain end position, and a time-domain center position. Certainly, in the embodiments of the present disclosure, the time-domain position associated with the CSI-RS resource configuration information may be determined based on the time-domain position of the time-domain resource occupied by the CSI-RS resource configuration information and a time-domain offset value 1. Here, the time-domain offset value 1 may be pre-defined, pre-configured, or configured by a network device.

For example, the time-domain resource is a symbol, and the reference time-domain resource may be the first symbol in the slot, and accordingly, the time-domain offset may be used for indicating a time-domain offset between the symbol occupied by the CSI-RS resource and the first symbol. Certainly, in the embodiments of the present disclosure, the reference time-domain resource may be e last symbol in the slot, and in this case, the time-domain offset may refer to a time-domain offset value that is offset along a direction of decreasing time.

In the embodiments of the present disclosure, the above-mentioned first symbol may be a symbol with an index of 0 in the slot, or a first SL symbol in the slot, where the position of the first SL symbol may be determined based on a sidelink start symbol (sl-StartSymbol) parameter in bandwidth part (BWP) configuration information.

In some scenarios, symbols available for transmitting the CSI-RS resource may not overlap with symbols for transmitting the following information: a PSCCH; a PSSCH DMRS; or second-stage SCI.

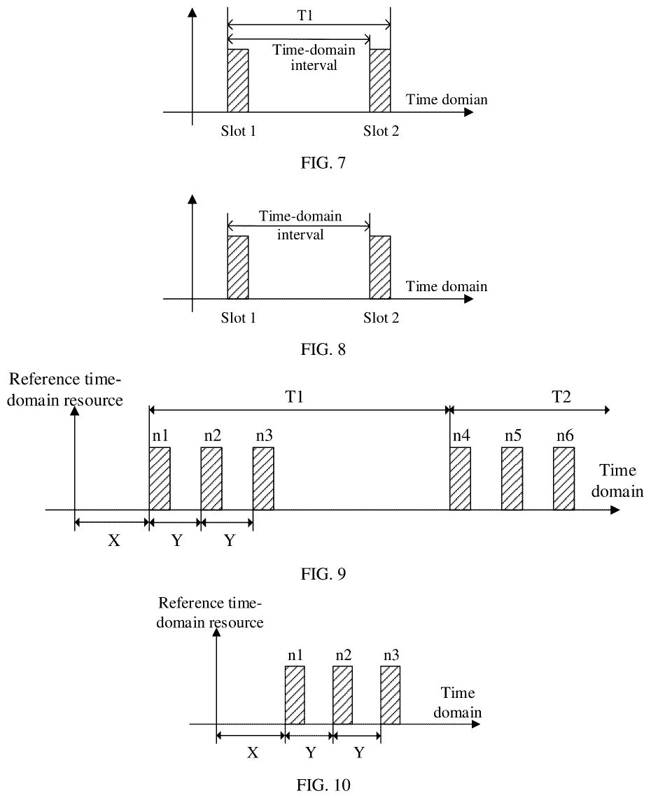

Taking an example in which the CSI-RS resource configuration information is used for configuring the time-domain interval between two adjacent CSI-RS resources within each period, the time-domain interval may refer to a time-domain interval between two slots containing CSI-RS resources within each period. The two slots may be two slots having a shortest time-domain distance in the time domain. Referring to FIG. 7, assuming that a period T1 includes a slot 1 and a slot 2, and the slot 1 and the slot 2 respectively include the time-domain resource corresponding to the CSI-RS resource. In this case, the above-mentioned time-domain interval may be a time-domain interval between the slot 1 and the slot 2.

In some implementations, the time-domain interval may be counted using a symbol as a time-domain resource, that is, the above-mentioned time-domain interval may refer to the number of symbols of an interval between two adjacent CSI-RS resources within each period. In other implementations, the time-domain interval may be counted using a slot as a time-domain resource, that is, the above-mentioned time-domain interval may refer to the number of slots of an interval between two adjacent CSI-RS resources within each period. Here, the time-domain interval may be an integer greater than or equal to 0.

It should be noted that, if the above-mentioned slot interval is 0, it may indicate that the above-mentioned two slots are adjacent in the time domain. Certainly, in the embodiments of the present disclosure, if the above-mentioned slot interval is 0, it may indicate that the above-mentioned two slots are adjacent logical slots in the sidelink resource pool, and in this case, these two slots are not necessarily adjacent in the time domain.

In the embodiments of the present disclosure, the above-mentioned time-domain interval may be pre-defined, pre-configured, or configured by a network device. Certainly, in the embodiments of the present disclosure, the above-mentioned time-domain interval may also be determined autonomously by the terminal device.

Take the example in which the CSI-RS resource configuration information is used for configuring the time-domain interval between two CSI-RS resources adjacent in the time domain, where these two CSI-RS resources may be two CSI-RS resources having the shortest time-domain distance in the time domain. Referring to FIG. 8, it is assumed that a time-domain resource 1 and a time-domain resource 2 include the time-domain resource corresponding to the CSI-RS resource, respectively, and in this case, the above-mentioned time-domain interval may be a time-domain interval between the time-domain resource 1 and the time-domain resource 2.

In some implementations, the above-mentioned time-domain interval may be counted using a symbol as a time-domain resource, that is, the above-mentioned time-domain interval may refer to the number of symbols of an interval between two adjacent CSI-RS resources. In other implementations, the above-mentioned time-domain interval may be counted using a slot as a time-domain resource, that is, the above-mentioned time-domain interval may refer to the number of slots of an interval between the two adjacent CSI-RS resources. Here, the time-domain interval may be an integer greater than or equal to 0.

It should be noted that, if the above-mentioned time-domain interval is 0, it may indicate that the above-mentioned two slots are adjacent in the time domain. Certainly, in the embodiments of the present disclosure, if the above-mentioned time-domain interval is 0, it may indicate that the above-mentioned two slots are adjacent logical slots in the sidelink resource pool, and in this case, these two slots are not necessarily adjacent in the time domain.

In the embodiments of the present disclosure, the above-mentioned time-domain interval may be pre-defined, pre-configured, or configured by a network device. Certainly, in the embodiments of the present disclosure, the above-mentioned time-domain interval may also be determined autonomously by the terminal device. In addition, in the embodiments of the present disclosure, the above-mentioned two adjacent time-domain resources may be any two adjacent time-domain resources among multiple time-domain resources available for transmitting the CSI-RS resource.

Taking the example in which the CSI-RS resource configuration information is used for configuring the number of time-domain resources capable of being occupied by the CSI-RS resource within each period, the number of time-domain resources capable of being occupied by the CSI-RS resource within each period may be replaced with the number of time-domain resources available for transmitting the CSI-RS resource within each period. Here, the number of time-domain resources may be an integer greater than or equal to 1.

In some implementations, the number of the above-mentioned time-domain resources may be the number of slots. Accordingly, the number of time-domain resources capable of being occupied by the CSI-RS resource within each period mentioned above is the number of slots capable of being occupied by the CSI-RS resource within each period. Certainly, in the embodiments of the present disclosure, the above-mentioned number of time-domain resources may also be the number of symbols.

In some implementations, the number of time-domain resources may be determined based on the number of transmit beams available to the transmitting end. For example, number of time-domain resources may be equal to the number of transmit beams available to the transmitting end. Assuming that the number of transmit beams available to the transmitting end is 4, the number of time-domain resources may be 4. For another example, the number of time-domain resources may be smaller than the number of transmit beams available to the transmitting end. For another example, the number of time-domain resources may be greater than the number of transmit beams available to the transmitting end.

Taking the example in which the CSI-RS resource configuration information is used for configuring the number of time-domain resources capable of being occupied by the CSI-RS resource, the number of time-domain resources capable of being occupied by the CSI-RS resource may be replaced with the number of time-domain resources available for transmitting the CSI-RS resource. Here, the number of time-domain resources may be an integer greater than or equal to 1.

In some implementations, the number of the time-domain resources may be the number of slots, and accordingly, the number of time-domain resources capable of being occupied by the CSI-RS resource is the number of slots capable of being occupied by the CSI-RS resource. Certainly, in the embodiments of the present disclosure, the number of time-domain resources may also be the number of symbols.

In some implementations, the number of time-domain resources may be determined based on the number of transmit beams available to the transmitting end. For example, the number of time-domain resources may be equal to the number of transmit beams available to the transmitting end. Assuming that the number of transmit beams available to the transmitting end is 4, the number of time-domain resources may be 4. For another example, the number of time-domain resources may be smaller than the number of transmit beams available to the transmitting end. For another example, the number of time-domain resources may be greater than the number of transmit beams available to the transmitting end.

A description is made below by taking the example in which the CSI-RS resource configuration information is used for configuring the period of the CSI-RS resource, alternatively, the CSI-RS resource configuration information is used for configuring a length of the period of the CSI-RS resource.

In some implementations, the period of the CSI-RS resource may be indicated by a parameter 1 in the CSI-RS resource configuration information. In some scenarios, the parameter may be set to a default value, and in this case, the parameter may be used to indicate that the CSI-RS resource is distributed aperiodically in the time domain. In other scenarios, the value of the parameter may be set to 0, and in this case, the parameter may be used to indicate that the CSI-RS resource is distributed aperiodically in the time domain.

In the embodiments of the present disclosure, the length of the period of the CSI-RS resource may be determined based on the number of time-domain resources, and taking the time-domain resources being slots as an example, the length of the period of the CSI-RS resource may include S slots, where S is a positive integer greater than or equal to 1. Taking the time-domain resources being symbols as an example, the length of the period of the CSI-RS resource may include D symbols, where D is a positive integer greater than or equal to 1.

Taking the example in which the CSI-RS resource configuration information is used for configuring the number of periodic transmissions of the CSI-RS resource, in some implementations, the number of periodic transmissions of the CSI-RS resource may be indicated by a parameter 2 in the CSI-RS resource configuration information. In some scenarios, the parameter may be set to a default value, and in this case, the parameter may be used to indicate that the CSI-RS resource is distributed aperiodically in the time domain. In other scenarios, the value of the parameter may be set to 0, and in this case, the parameter may be used to indicate that the CSI-RS resource is distributed aperiodically in the time domain.

It should be noted that the aperiodic distribution of the CSI-RS resource in the time domain may be understood as that the CSI-RS resource to be transmitted shall not be repeated periodically in the time domain. In addition, in the embodiments of the present disclosure, the value of the above-mentioned parameter 2 may be a positive integer greater than or equal to 0.

Taking an example in which the CSI-RS resource configuration information is used for configuring the indication information of the time-domain resource occupied by the CSI-RS resource, in some implementations, the indication information may be an index of the time-domain resource occupied by the CSI-RS resource. Taking the time-domain resource being a symbol as an example, the indication information may include an index of the symbol occupied by the CSI-RS resource.

In some implementations, the CSI-RS resource may occupy multiple symbols in a slot, and in this case, the above-mentioned index may be used for indicating a start symbol of the multiple symbols occupied by the CSI-RS, or the above-mentioned index may be used for indicating an end symbol of the multiple symbols occupied by the CSI-RS resource, which is not limited in the embodiments of the present disclosure.

Accordingly, the number of the multiple symbols mentioned above may be pre-defined, pre-configured, or configured by a network device. Certainly, in the embodiments of the present disclosure, the above-mentioned multiple symbols may also be determined based on a first condition, where the first condition may be used to indicate that a symbol corresponding to the index is the start symbol, and that multiple symbols for transmitting the PSSCH after the start symbol may be all available for transmitting the CSI-RS resource. That is, all symbols between the start symbol and the last symbol available for transmitting the PSSCH may be all available for transmitting the CSI-RS resource.

For example, the start symbol is a symbol with an index 2 in a slot 1, and an index of the last symbol available for transmitting the PSSCH in the slot 1 is 13, then all symbols between the symbol with the index 2 and the symbol with the index 13 may be all available for transmitting the CSI-RS resource.

Certainly, in the embodiments of the present disclosure, the CSI-RS resource may occupy only one symbol, and accordingly, the above-mentioned index is the index of the symbol occupied by the CSI-RS resource.

In other implementations, the indication information may be a bitmap, where each bit in the bitmap may correspond to a time-domain resource, and the value of the bit may be used to indicate whether the corresponding time-domain resource is available for transmitting the CSI-RS resource. Taking the time-domain resource being a symbol as an example, each bit in the bitmap may correspond to a symbol, where the value of the bit may be used to indicate whether the corresponding symbol is available for transmitting the CSI-RS resource.

For example, the value of the bit is a first value, which may be used to indicate that the corresponding time-domain resource is available for transmitting the CSI-RS resource. For another example, the value of the bit is the second value, which may be used to indicate that the corresponding time-domain resource is not available for transmitting the CSI-RS resource. The first value and the second value may be different values. The first value may be 0 and the second value may be 1. Alternatively, the first value may be 1 and the second value may be 0.

The CSI-RS resource configuration information used for configuring the time-domain resource position of the CSI-RS resource in the embodiments of the present disclosure is introduced above, and in the embodiments of the present disclosure, the above-mentioned CSI-RS resource configuration information may be used separately or in combination. Two solutions used in combination with each other are introduced below in conjunction with Implementation 1 to Implementation 4, and it should be understood that the solutions in combination with each other are not limited in the embodiments of the present disclosure.

Implementation 1: the CSI-RS resource configuration information may include the time-domain offset of the CSI-RS resource; the period of the CSI-RS resource; the time-domain interval between two CSI-RS resources adjacent within each period; the number of time-domain resources capable of being occupied by the CSI-RS resource within each period; and the number of periodic transmissions of the CSI-RS resource.

The time-domain position of the CSI-RS resource configured by the CSI-RS resource configuration information in the embodiments of the present disclosure is introduced below with reference to FIG. 9. It is assumed that the CSI-RS resource configuration information is used for configuring the following information: the period of the CSI-RS resource being T and each period including (containing) 3 CSI-RS resources; the number of periodic transmissions of the CSI-RS resource being 2; the time-domain offset of the CSI-RS resource being X slots; the reference time-domain resource being slot n0, and the first CSI-RS resource being a CSI-RS resource 1; and the time-domain interval between two adjacent CSI-RS resources being Y slots.

Accordingly, based on the above-mentioned CSI-RS resource configuration information, the configured CSI-RS resource includes the CSI-RS resource 1 to the CSI-RS resource 3 within the period T1, where the CSI-RS resource 1 is the first CSI-RS resource among the three CSI-RS resources, and the time-domain offset between the CSI-RS resource 1 and the slot no is X slots, and therefore, the CSI-RS resource 1 occupies the slot n1. The time-domain interval between the CSI-RS resource 1 and the CSI-RS resource 2 is Y slots, and therefore, the CSI-RS resource 2 occupies the slot n2. The time-domain interval between the CSI-RS resource 2 and the CSI-RS resource 3 is Y slots, and therefore, the CSI-RS resource 3 occupies the slot n3. The period T2 includes a CSI-RS resource 4 to a CSI-RS resource 6, where the time-domain position of the CSI-RS resource 4 is the slot n1+T, the time-domain position of the CSI-RS resource 5 is the slot n2+T, and the time-domain position of the CSI-RS resource 6 is the slot n3+T.

Implementation 2: the CSI-RS resource configuration information may include: the time-domain offset of the CSI-RS resource; the time-domain interval between two CSI-RS resources adjacent in the time domain; and the number of time-domain resources capable of being occupied by the CSI-RS resource.

The time-domain position of the CSI-RS resource configured by the CSI-RS resource configuration information in the embodiments of the present disclosure is introduced below with reference to FIG. 10. It is assumed that the CSI-RS resource configuration information is used for configuring the following information: the number of time-domain resources capable of being occupied by the CSI-RS resource being 3; the time-domain offset of the CSI-RS resource being X slots; the reference time-domain resource being slot n0; the first CSI-RS resource being a CSI-RS resource 1; and the time-domain interval between two adjacent CSI-RS resources being Y slots.

Accordingly, based on the above-mentioned CSI-RS resource configuration information, it can be seen that the configured CSI-RS resource includes the CSI-RS resource 1 to the CSI-RS resource 3, where the CSI-RS resource 1 is the first CSI-RS resource among the three CSI-RS resources, and the time-domain offset between the CSI-RS resource 1 and the slot no is X slots, and therefore, the CSI-RS resource 1 occupies the slot n1. The time-domain interval between the CSI-RS resource 1 and the CSI-RS resource 2 is Y slots, and therefore, the CSI-RS resource 2 occupies the slot n2. The time-domain interval between the CSI-RS resource 2 and the CSI-RS resource 3 is Y slots, and therefore, the CSI-RS resource 3 occupies the slot n3.

The time-domain position of the slot occupied by the CSI-RS resource in the embodiments of the present disclosure is introduced above in conjunction with the Implementation 1 and Implementation 2. Therefore, the above methods may also be referred to as “slot-level configuration of the CSI-RS resource” or “slot-level indication of the CSI-RS resource.” As introduced above, the time-domain resource in the embodiments of the present disclosure may be the symbol, and therefore, the time-domain position of the symbol occupied by the CSI-RS resource in the embodiments of the present disclosure is introduced below in conjunction with Implementation 3 and Implementation 4, and accordingly, Implementation 3 and Implementation 4 may also be referred to as “symbol-level configuration of the CSI-RS resource” or “symbol-level indication of the CSI-RS resource.”

In some scenarios, one slot may have only one symbol available for transmitting the CSI-RS resource. In other scenarios, one slot includes multiple symbols available for transmitting the CSI-RS resource. In this case, the time-domain position of the CSI-RS resource may be indicated based on the symbol-level indication of the CSI-RS resource.

Implementation 3: in a case where one slot has only one symbol available for transmitting the CSI-RS resource, the CSI-RS resource configuration information may include the time-domain offset of the CSI-RS resource.

For example, the CSI-RS resource configuration information is used for configuring the time-domain offset of the CSI-RS resource to be 5 symbols. Accordingly, if the index of the first SL symbol in the slot 1 is 2, the index of the symbol available for transmitting the CSI-RS resource is 7 in this case.

For another example, the CSI-RS resource configuration information is used for configuring the index of the symbol available for transmitting the CSI-RS resource to be 7. Accordingly, the symbol with the index 7 in the slot 1 is available for transmitting the CSI-RS resource, where the index range of symbols in the slot 1 is 0 to 13.

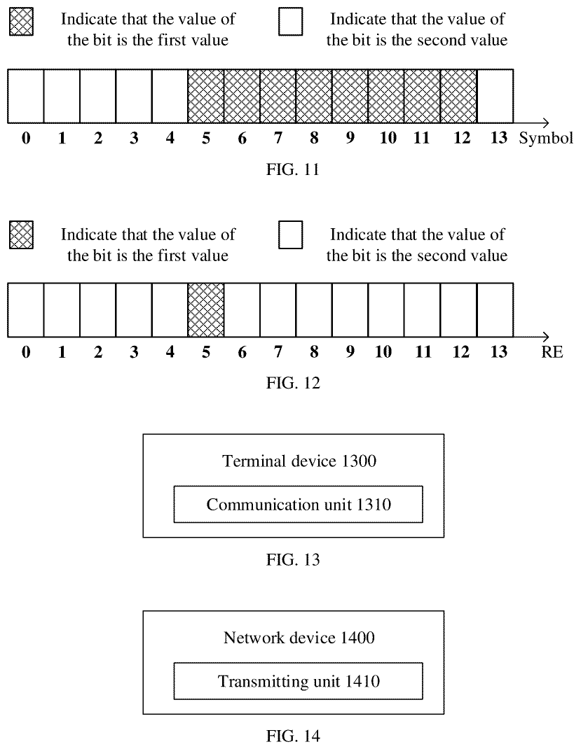

Implementation 4: in a case where one slot includes multiple symbols available for transmitting the CSI-RS resource, the CSI-RS resource configuration information may include a bitmap. As illustrated in FIG. 11, the values of the 5th bit to 12th bit in the bitmap are a first value, and the values of the remaining bits are a second value. In this case, it may be determined that the symbol 5 to symbol 12 in the slot 1 corresponding to the 5th bit to 12th bit are available for transmitting the CSI-RS resource. The remaining bits (the symbol 0 to symbol 4 in the slot 1 corresponding to the 0th bit to 4th bit) are not available for transmitting the CSI-RS resource. In addition, the symbol 13 in the slot 1 corresponding to the 13th bit is also not available for transmitting the CSI-RS resource.

In the embodiments of the present disclosure, the above-mentioned symbol-level indication of the CSI-RS resource and slot-level indication of the CSI-RS resource may be used separately. In some implementations, the CSI-RS resource configuration information may configure the slot-level indication only, and accordingly, the symbol-level indication of the CSI-RS resource may be determined by pre-configuration information, for example, determined by resource pool configuration information and/or SL BWP configuration information. Certainly, the symbol-level indication of the CSI-RS resource may be determined by pre-defined information, for example, determined by information predefined by a protocol. In other implementations, the CSI-RS resource configuration information may configure the symbol-level indication only, and accordingly, the slot-level indication of the CSI-RS resource may be determined by pre-configuration information, or the slot-level indication of the CSI-RS resource may be determined by pre-defined information.

Certainly, in the embodiments of the present disclosure, the above-mentioned symbol-level indication of the CSI-RS resource and slot-level indication of the CSI-RS resource may be used in combination with each other. That is, the CSI-RS resource configuration information may be used for the symbol-level indication and slot-level indication of the CSI-RS resource. For example, Implementation 1 may be used in combination with Implementation 3. For another example, Implementation 1 may be used in combination with Implementation 4. For another example, Implementation 2 may be used in combination with Implementation 3. For another example, Implementation 2 may be used in combination with Implementation 4.

### Example 4-2: The CSI-RS Resource Configuration Information is Used for Configuring the Frequency-Domain Resource Position of the CSI-RS Resource

In the embodiments of the present disclosure, the frequency-domain resource may be a PRB, a subchannel, or the like; alternatively, the frequency-domain resource may be a frequency-domain unit newly introduced in the future communication system.

In some implementations, the CSI-RS resource configuration information is used for configuring one or more of: a frequency-domain start position of the CSI-RS resource; a frequency-domain length capable of being occupied by the CSI-RS resource; a frequency-domain interval between two CSI-RS resources adjacent in the frequency domain; and indication information of a frequency-domain resource capable of being occupied by the CSI-RS resource.

The case that the CSI-RS resource configuration information is used for configuring the frequency-domain start position of the CSI-RS resource may be understood that the CSI-RS resource configuration information is used for configuring a frequency-domain position corresponding to the lowest frequency in frequency-domain resources occupied by the CSI-RS resource.

In the embodiments of the present disclosure, the above-mentioned frequency-domain start position may be at the PRB granularity. Alternatively, the frequency-domain start position may be at the subchannel granularity.

In the embodiments of the present disclosure, the above-mentioned frequency-domain start position of the CSI-RS resource may be determined based on the frequency-domain offset. In some implementations, the frequency-domain offset may be a frequency-domain offset between a start frequency-domain position of the resource pool and a frequency-domain start position of the CSI-RS resource. For example, the start frequency-domain position of the resource pool is PRB #10, and the frequency-domain offset value is a frequency range corresponding to 5 PRBs, then the frequency-domain start position of the CSI-RS resource is PRB #15. In other implementations, the frequency-domain offset may be the frequency-domain offset between the start frequency-domain position of the SL BWP and the frequency-domain start position of the CSI-RS resource.

In other implementations, the above-mentioned frequency-domain start position of the CSI-RS resource may be determined by an index of the frequency-domain resource. For example, the frequency-domain start position of the CSI-RS resource may be a frequency-domain resource indicated by the index. For another example, the frequency-domain start position of the CSI-RS resource may be determined by the frequency-domain resource indicated by the index and a frequency-domain offset value 1, where the frequency-domain offset value 1 may be preset, pre-configured, or pre-defined.

In some implementations, the frequency-domain end position of the CSI-RS resource may be determined based on the frequency-domain start position and a frequency-domain length of the CSI-RS resource. Here, the frequency-domain length may be pre-defined or pre-configured, and in this case, the CSI-RS resource configuration information may not be used for configuring the frequency-domain length. Certainly, in the embodiments of the present disclosure, the frequency-domain length may also be configured through the CSI-RS resource configuration information, which may refer to the introduction below.

If the CSI-RS resource configuration information is used for configuring the frequency-domain length capable of being occupied by the CSI-RS resource, in some implementations, the frequency-domain length may be identified by a frequency range. In other implementations, the frequency-domain length may be represented by the number of frequency-domain units, and taking the example in which the frequency-domain resource is the PRB, the frequency-domain length may be represented by the number of PRBs. Taking the example in which the frequency-domain resource is the sub-channel, the frequency-domain length may be represented by the number of sub-channels.

In the embodiments of the present disclosure, information of the above-mentioned frequency-domain start position and frequency-domain length of the CSI-RS resource may be indicated separately. For example, x bits in the CSI-RS resource configuration information are used for indicating the frequency-domain start position of the CSI-RS resource, and accordingly, y bits in the CSI-RS resource configuration information may be used for indicating the frequency-domain length. Certainly, in the embodiments of the present disclosure, the information of the frequency-domain start position and frequency-domain length of the CSI-RS resource may be indicated by common indication information. For example, the common indication information may be a frequency (domain) resource indicator value, and the frequency (domain) resource indicator value may correspond to a combination of the frequency-domain start position and frequency-domain length of the CSI-RS resource. That is, the size of the common indication information may be z bits, and the value of the z bits may correspond to the frequency-domain start position and the frequency-domain length of the CSI-RS resource.

It should be noted that, within the frequency range corresponding to the frequency-domain length, the frequency-domain resources available for transmitting the CSI-RS resource may be continuous in the frequency domain, or, within the frequency range corresponding to the frequency-domain length, the frequency-domain resources available for transmitting the CSI-RS resource may be discontinuous in the frequency domain, or in other words, the frequency-domain resources available for transmitting the CSI-RS resource may be discrete in the frequency domain.

In some implementations, in a case where the frequency-domain resources available for transmitting the CSI-RS resource may be discrete in the frequency domain, the frequency-domain interval between the frequency-domain resources used for transmitting the CSI-RS resource may be pre-defined and pre-configured, and in this case, the CSI-RS resource configuration information may not be used for configuring the frequency-domain interval. Certainly, in the embodiments of the present disclosure, the frequency-domain interval may also be configured through the CSI-RS resource configuration information, which may refer to the introduction below.

For example, assuming that the CSI-RS resource configuration information is used for configuring the frequency-domain start position of the CSI-RS resource to be PRB #5, and in addition, the frequency-domain interval is 5 PRBs, then, the PRBs available for transmitting the CSI-RS resource are PRB #5, PRB #10, PRB #15, and so on.

In a case where the CSI-RS resource configuration information is used for configuring the frequency-domain interval between two CSI-RS resources adjacent in the frequency domain, the two CSI-RS resources may be two PRBs having the shortest frequency domain distance in the frequency domain. Assuming that the CSI-RS resources occupy the frequency-domain resource 1 and the frequency-domain resource 2, the above-mentioned frequency-domain interval may be a frequency-domain interval between the frequency-domain resource 1 and the frequency-domain resource 2 in this case.

In some implementations, the above-mentioned frequency-domain interval may be counted by using the subchannel as the frequency-domain resource. That is, the frequency domain interval may refer to the number of subchannels of an interval between two adjacent CSI-RS resources. In other implementations, the above-mentioned frequency-domain interval may be counted by using the PRB as the frequency-domain resource, that is, the above-mentioned frequency-domain interval may refer to the number of PRBs of an interval between two adjacent CSI-RS resources. Here, the frequency-domain interval may be an integer greater than or equal to 0.

It should be noted that, if the above-mentioned frequency-domain interval is 0, it may indicate that the above-mentioned two frequency-domain resources for transmitting the CSI-RS resources are adjacent in the frequency domain. Certainly, in the embodiments of the present disclosure, if the above-mentioned PRB interval is a default value (or in other words, the CSI-RS resource configuration information does not configure the frequency-domain interval), it may indicate that the above-mentioned two frequency-domain resources for transmitting the CSI-RS resources are adjacent in the frequency domain.

In a case where the CSI-RS resource configuration information is used for configuring the indication information of the frequency-domain resource capable of being occupied by the CSI-RS resource, in some implementations, the indication information may be an index of the frequency-domain resource occupied by the CSI-RS resource. Taking the example in which the frequency-domain resource is the PRB, the indication information may include an index of a PRB occupied by the CSI-RS resource. Taking the example in which the frequency-domain resource is a resource element (RE), the indication information may include an index of an RE occupied by the CSI-RS resource.

In some implementations, the CSI-RS resource may occupy multiple REs in the PRB, and in this case, the above-mentioned index may be used for indicating a start RE among the multiple REs occupied by the CSI-RS, or the above-mentioned index may be used for indicating an end RE among the multiple REs occupied by the CSI-RS resource, which is not limited in the embodiments of the present disclosure.

For example, the start RE is an RE with an index 2 in a PRB1, and an index of a last RE in the PRB1 that is available for transmitting the PSSCH is 11, then all REs between the RE with the index 2 and the RE with the index 11 are all available for transmitting the CSI-RS resource.

Certainly, in the embodiments of the present disclosure, the CSI-RS resource may occupy only one RE, and accordingly, the above-mentioned index is the index of the RE occupied by the CSI-RS resource.

In other implementations, the indication information may be a bitmap, and each bit in the bitmap may correspond to a frequency-domain resource, where the value of the bit may be used to indicate whether the corresponding frequency-domain resource is available for transmitting the CSI-RS resource. Taking the example in which the frequency-domain resource is the RE, each bit in the bitmap may correspond to an RE, where the value of the bit may be used to indicate whether the corresponding RE is available for transmitting the CSI-RS resource.

For example, the value of the bit being a first value may be used to indicate that the corresponding frequency-domain resource is available for transmitting the CSI-RS resource. For another example, the value of the bit being the second value may be used to indicate that the corresponding frequency-domain resource is not available for transmitting the CSI-RS resource. Here, the first value and the second value may be different values, where the first value may be 0 and the second value may be 1. Alternatively, the first value may be 1 and the second value may be 0.

As illustrated in FIG. 12, in the case where the CSI-RS resource occupies multiple REs, the CSI-RS resource configuration information may include the bitmap. The value of the 5th bit in the bitmap is the first value, and the values of the remaining bits are the second value. In this case, it may be determined that the RE5 in the PRB1 corresponding to the 5th bit is available for transmitting the CSI-RS resource. The remaining bits (the RE0 to RE4 in the PRB1 corresponding to the 0th bit to 4th bit) are not available for transmitting the CSI-RS resource, and in addition, the RE6 to RE13 in the PRB1 corresponding to the 6th bit to 11th bit are not available for transmitting the CSI-RS resource.

In the embodiments of the present disclosure, the above-mentioned RE-level indication of the CSI-RS resource and the PRB-level (or subchannel-level) indication of the CSI-RS resource may be used separately. In some implementations, the CSI-RS resource configuration information may configure the PRB-level (or subchannel-level) indication only. Accordingly, the RE-level indication of the CSI-RS resource may be determined by pre-configuration information, for example, determined by resource pool configuration information and/or SL BWP configuration information. Certainly, the RE-level indication of the CSI-RS resource may be determined by pre-defined information, for example, determined by information predefined by a protocol. In other implementations, the CSI-RS resource configuration information may configure the RE-level indication only. Accordingly, the PRB-level (or subchannel-level) indication of the CSI-RS resource may be determined by pre-configuration information; alternatively, the PRB-level (or subchannel-level) indication of the CSI-RS resource may be determined by pre-defined information.

Certainly, in the embodiments of the present disclosure, the above-mentioned RE-level indication of the CSI-RS resource and the PRB-level (or subchannel-level) indication of the CSI-RS resource may be used in combination with each other. That is, the CSI-RS resource configuration information may be used for the RE-level indication and the PRB-level (or subchannel-level) indication of the CSI-RS resource.

### Example 4-3: The CSI-RS Resource Configuration Information is Used for Configuring the Transmit Beam Associated with the CSI-RS Resource

Generally, the transmitting end of the CSI-RS may use the same transmit beam or different transmit beam when transmitting the CSI-RS. For example, in response to the transmitting end of the CSI-RS using the different transmit beam, the receiving end of the CSI-RS may use the same receive beam to receive the CSI-RS, and the receiving end of the CSI-RS may select a relatively optimal transmit beam according to the measurement result. Then, the receiving end of the CSI-RS may indicate the selected transmit beam to the transmitting end of the CSI-RS. For another example, in response to the transmitting end of the CSI-RS using the same transmit beam, the receiving end of the CSI-RS uses the different receive beam to receive the CSI-RS, and the receiving end of the CSI-RS may select a relatively optimal receive beam according to the measurement result. Then, the receiving end of the CSI-RS may indicate the selected transmit beam to the transmitting end of the CSI-RS. Therefore, in order to facilitate the selection of a suitable transmit beam, the transmit beam associated with the CSI-RS resource may be indicated in the above-mentioned CSI-RS resource configuration information.

In some implementations, the CSI-RS resource configuration information is used for configuring that the transmit beam associated with the CSI-RS resource is same or different. Therefore, this information may be understood as a repetition switch, and in a case where the repetition switch is turned on, the transmit beam associated with the CSI-RS resource configured by the CSI-RS resource configuration information is the same. Otherwise, in a case where the repetition switch is turned off, the transmit beam associated with the CSI-RS resource configured by the CSI-RS resource configuration information is different.

In some implementations, the CSI-RS resource configuration information may include a first parameter. The first parameter is used for indicating whether the transmit beams associated with the CSI-RS resources included in a period are the same or different.

For example, in the CSI-RS resource configuration method shown in Implementation 1, in the case where the repetition switch is turned on, the transmit beams associated with the CSI-RS resources in the period T1 are the same. In the case where the repetition switch is turned off, the transmit beams associated with the CSI-RS resources in the period T1 are different.

In some implementations, the CSI-RS resource configuration information may include a second parameter, and the second parameter is used for indicating whether the transmit beams associated with the CSI-RS resources included in a time domain unit are same or different. Here, the time domain unit may be a slot, a subframe, or the like.

For example, based on Implementation 2, time-domain resources for transmitting the shown CSI-RS resources in a slot may be configured, and in the case where the repetition switch is turned on, the transmit beams associated with the CSI-RS resources in a slot are same. In the case where the repetition switch is turned off, the transmit beams associated with the CSI-RS resources in a slot are different.

In some implementations, the CSI-RS resource configuration information may include a third parameter, and the third parameter is used for indicating whether the transmit beam associated with the CSI-RS resource included within each period is same or different.

For example, in the CSI-RS resource configuration method shown in Implementation 1, in the case where the repetition switch is turned on, the transmit beams associated with the CSI-RS resources in the period T1 are the same, and the transmit beams associated with the CSI-RS resources in the period T2 are the same. In the case where the repetition switch is turned off, the transmit beams associated with the CSI-RS resources in the period T1 and the period T2 are different.

In some implementations, the CSI-RS resource configuration information may be carried by one or more of: SCI; an MAC CE; and PC5-RRC. In other implementations, the priority of the CSI-RS resource configuration information may be set to the highest priority, which helps to prioritize the transmission of the CSI-RS resource configuration information. For example, in a case where the CSI-RS resource configuration information is carried by the SCI, the value of the priority of the SCI may be set to the highest priority. For another example, in a case where the CSI-RS resource configuration information is carried by the MAC CE, the priority of the MAC CE may be set to the highest priority.

In the embodiments of the present disclosure, the priority of the above-mentioned CSI-RS resource configuration information may be determined based on pre-configuration information or information configured by a network.

### Example 5: The First Information Includes the First CSI-RS Resource Information

In some implementations, the first CSI-RS resource information is used for selecting the second transmit beam; or in other words, the first CSI-RS resource information is used for reselecting the second transmit beam.

In some scenarios, the beam failure refers to that all candidate beams (e.g., the candidate transmit beams introduced above) have failed or there are no candidate beams, and in this case, it is necessary to reselect a transmit beam. Accordingly, the reselection for the beam may be performed according to indication information of the first CSI-RS resource.

In some implementations, the above-mentioned first CSI-RS resource information includes information of one or more CSI-RS resources, where the information of the one or more CSI-RS resources may include identification information of the one or more CSI-RS resources, and the identification information of the CSI-RS resource is used for distinguishing the one or more CSI-RS resources. Accordingly, transmit beams associated with the one or more CSI-RS resources may include the second transmit beam.

In some implementations, the above-mentioned process of selecting the transmit beam may include that: the transmitting end transmits first CSI-RS resource configuration information to the receiving end, and accordingly, the receiving end performs, based on the first CSI-RS resource configuration information, measurement on the CSI-RS associated with the first CSI-RS resource configuration information, to obtain a measurement result of each CSI-RS. Then, the receiving end may select one or more CSI-RS resource information based on the measurement result to report to the transmitting end, where the one or more CSI-RS resource information includes a corresponding CSI-RS resource identifier. Accordingly, the transmitting end selects a target CSI-RS from CSI-RSs associated with the one or more CSI-RS resource information, and a transmit beam associated with the target CSI-RS is the reselected transmit beam, i.e., the second transmit beam.

### Example 6: The First Information Includes the First Measurement Result Corresponding to the First CSI-RS Resource Information

In some implementations, the first measurement result corresponding to the first CSI-RS resource information may include measurement results corresponding to one or more CSI-RSs included in the first CSI-RS resource information.

In the embodiments of the present disclosure, the receiving end may perform measurement on the one or more received CSI-RSs and obtain the measurement results corresponding to the one or more CSI-RSs, and then, the receiving end may select transmit beams associated with the one or more CSI-RSs (i.e., the CSI-RSs included in the first CSI-RS resource information) as candidate beams, based on the measurement results. The receiving end may transmit the measurement results of the candidate transmit beams to the transmitting end, so that the transmitting end selects a suitable transmit beam (e.g., the second transmit beam) from the candidate transmit beams.

It should be noted that the one or more CSI-RSs received by the receiving end may be some CSI-RSs of the multiple CSI-RSs transmitted from the transmitting end. That is, for the multiple CSI-RS resources transmitted from the transmitting end, the receiving end may autonomously select some CSI-RSs for measurement. In addition, there may be a case where the receiving end does not detect some CSI-RSs. Accordingly, the CSI-RSs associated with the first measurement result may be some CSI-RSs of the multiple CSI-RSs transmitted from the transmitting end. Certainly, in the embodiments of the present disclosure, the one or more CSI-RSs received by the receiving end may be all CSI-RSs of the multiple CSI-RSs transmitted from the transmitting end.

From the perspective of the receiving end, the receiving end selects, from the CSI-RS resources for which the measurement results are obtained, one or more CSI-RSs to report, where the one or more CSI-RSs selected by the receiving end are the CSI-RSs included in the first CSI-RS resource information. For ease of the subsequent description, the one or more CSI-RS resources for which the measurement results are obtained by the receiving end are referred to as a first CSI-RS resource set, hereafter. That is, the CSI-RS resource associated with the first CSI-RS resource information may be a subset of the first CSI-RS resource set. Certainly, the CSI-RS resource associated with the first CSI-RS resource information may be all CSI-RS resources in the first CSI-RS resource set.

In some implementations, the receiving end may randomly select one or more CSI-RS resources from the first CSI-RS resource set, and the transmit beam corresponding to the selected CSI-RS resource is the relatively optimal transmit beam selected by the receiving end, i.e., the candidate transmit beam introduced above.

In some implementations, the N CSI-RSs selected by the receiving end may be CSI-RSs associated with the most optimal N measurement results in the first CSI-RS resource set. For example, the corresponding N CSI-RS resources may be selected in the descending order of the measurement results. Here, N is a positive integer greater than or equal to 1, and the value of Nis less than or equal to the number of CSI-RS resources in the first CSI-RS resource set.

In some implementations, the CSI-RS resource selected by the receiving end may be determined based on the following conditions: the measurement result corresponding to the CSI-RS resource being greater than a measurement result threshold, and the maximum number of CSI-RS resources selected by the receiving end being N. For example, the CSI-RS resources in the first CSI-RS resource set may be sorted in the descending order of the measurement results. Assuming that only M CSI-RS resources with the corresponding measurement results greater than the measurement result threshold, among the sorted CSI-RS resources, and then even if the value of M is smaller than the value of N, the receiving end may select the M CSI-RS resources only. Here, the measurement result threshold and/or the value of N may be determined by pre-definition, configuration by the network device, or pre-configuration.

Taking the example in which the value of M is 2 and the value of N is 3, the CSI-RS resources in the first CSI-RS resource set may be sorted in the descending order of the measurement results. Assuming that only two CSI-RS resources with the corresponding measurement results greater than the measurement result threshold among the sorted CSI-RS resources, the receiving end may select the two CSI-RS resources only.

Taking the example in which the value of N is 1, the CSI-RS resources in the first CSI-RS resource set may be sorted in the descending order of the measurement results, and the receiving end may only select a CSI-RS resource with the corresponding maximum measurement result and this measurement result greater than the measurement result threshold, in the first CSI-RS resource set.

In addition, in the embodiments of the present disclosure, the value of N may depend on pre-configuration information or information configured by a network; alternatively, the value of N may be pre-defined by a protocol. Certainly, in the embodiments of the present disclosure, the value of N may be determined based on an implementation of the terminal.

In some implementations, the first CSI-RS resource information may be transmitted simultaneously with the first measurement result, that is, the first information includes the first CSI-RS resource information and the first measurement result. Here, there is a correspondence between the CSI-RSs in the first CSI-RS resource information and the measurement results included in the first measurement result, and the correspondence may be, for example, a one-to-one correspondence.

In some implementations, the CSI-RS resources of the multiple CSI-RSs in the first CSI-RS resource information may be carried in the first information in a first order. Accordingly, the measurement results of the multiple CSI-RSs included in the first measurement result may be carried in the first information in the first order. In this way, the transmitting end is facilitated to determine the measurement results associated with the CSI-RSs in the first CSI-RS resource information.

In other implementations, the above-mentioned first measurement result may be omitted, that is, the first information may carry the CSI-RS resource information but not carry the first measurement result. In this case, the multiple CSI-RS resources included in the first CSI-RS resource information may be sorted in a second order, and accordingly, the transmitting end may select the relatively optimal transmit beam based on the second order. Here, the second order may be a descending order of the measurement results corresponding to the CSI-RS resources, or, the second order may be an ascending order of the measurement results corresponding to the CSI-RS resources. In the embodiments of the present disclosure, the second order may be pre-configured, configured by the network device, or pre-defined.

In some implementations, the above-mentioned first CSI-RS resource information may be carried by one or more of: SCI; an MAC CE; and PC5-RRC. In other implementations, the priority of the first CSI-RS resource information may be set to the highest priority, which helps to prioritize the transmission of the first CSI-RS resource information. For example, in a case where the first CSI-RS resource information is carried by the SCI, the value of the priority of the SCI may be set to the highest priority. For another example, in a case where the first CSI-RS resource information is carried by the MAC CE, the priority of the MAC CE may be set to the highest priority.

In the embodiments of the present disclosure, the above-mentioned priority of the first CSI-RS resource information may be determined based on pre-configuration information or information configured by a network.

Example 7: the first information includes the beam failure recovery information. In some implementations, the above-mentioned beam failure recovery information may be used for indicating the beam failure recovery, or the above-mentioned beam failure recovery information may be used for indicating an acknowledgement of recovery of the beam failure, and therefore, the information may also be referred to as “beam recovery acknowledgement information”.

In some implementations, the above-mentioned information may be transmitted from the transmitting end of the sidelink signal to the receiving end. For example, the transmitting end, after selecting a suitable transmit beam, may transmit the beam failure recovery information to the receiving end, to indicate the acknowledgement of the beam recovery.

In some implementations, the above-mentioned beam failure recovery information may be carried by one or more of: SCI; an MAC CE; and PC5-RRC. In other implementations, the priority of the beam failure recovery information may be set to the highest priority, which helps to prioritize the transmission of the beam failure recovery information. For example, in a case where the beam failure recovery information is carried by the SCI, the value of the priority of the SCI may be set to the highest priority. For another example, in a case where the beam failure recovery information is carried by the MAC CE, the priority of the MAC CE may be set to the highest priority.

In the embodiments of the present disclosure, the above-mentioned priority of the beam failure recovery information may be determined based on pre-configuration information or information configured by a network.

### Example 8: The First Information Includes the Second CSI-RS Resource Information

In some implementations, the second CSI-RS resource information is used for indicating the selected second transmit beam; or in other words, the second CSI-RS is used for indicating the second transmit beam selected by the transmitting end of the sidelink transmission.

In some implementations, the second CSI-RS resource information includes CSI-RS resource information associated with the second transmit beam, for example, the second CSI-RS resource information may include a CSI-RS resource identifier associated with the second transmit beam.

In some implementations, the above-mentioned second CSI-RS resource information may be transmitted by the transmitting end of the sidelink signal to the receiving end. For example, the transmitting end, after selecting a suitable transmit beam, may transmit the second CSI-RS resource information to the receiving end, to indicate the selected transmit beam (i.e., the second transmit beam). Here, the method for the transmitting end to select the second transmit beam may refer to the above introduction, which is not repeated for brevity.

In some implementations, the CSI-RS resource associated with the second CSI-RS resource information may be one or more of the one or more CSI-RS resources included in the first CSI-RS resource information introduced above.

In some implementations, in a case where the first CSI-RS resource information includes one CSI-RS resource, the CSI-RS resource included in the second CSI-RS resource information is the CSI-RS resource included in the first CSI-RS resource information. That is, in response to that the first CSI-RS resource indication information received by the transmitting end and reported by the receiving end includes only one CSI-RS resource, the transmit beam used by the transmitting end for a subsequent sidelink transmission (the second transmit beam) is the transmit beam corresponding to that CSI-RS resource.

In some implementations, the above-mentioned beam failure recovery information and second CSI-RS resource information may be transmitted simultaneously. In other implementations, the above-mentioned beam failure recovery information and second CSI-RS resource information may be transmitted separately.

In some implementations, in order to reduce the transmission resources required for transmitting the above-mentioned information, the second CSI-RS resource information may be multiplexed to indicate the beam failure recovery. That is, the second CSI-RS resource information may indicate the second transmit beam and meanwhile indicate the beam failure recovery. In this case, a dedicated bit is required to be additionally set in the first information to indicate the beam failure recovery.

In some implementations, the above-mentioned second CSI-RS resource information may be carried by one or more of: SCI; an MAC CE; and PC5-RRC. In other implementations, the priority of the second CSI-RS resource information may be set to the highest priority, which helps to prioritize the transmission of the second CSI-RS resource information. For example, in a case where the second CSI-RS resource information is carried by the SCI, the value of the priority of the SCI may be set to the highest priority. For another example, in a case where the second CSI-RS resource information is carried by the MAC CE, the priority of the MAC CE may be set to the highest priority.

In the embodiments of the present disclosure, the above-mentioned priority of the second CSI-RS resource information may be determined based on pre-configuration information or information configured by a network.

It should be noted that the CSI-RS introduced above may be a CSI-RS transmitted through the sidelink, and therefore, the above-mentioned CSI-RS may be replaced with an SL CSI-RS.

In the embodiments of the present disclosure, the first information introduced in conjunction with Example 1 to Example 8 may be used separately or in combination with each other. In addition, in the embodiments of the present disclosure, the above-introduced Examples of the first information may be transmitted simultaneously or separately.

The first information in the embodiments of the present disclosure is introduced above, and the method for determining a sidelink resource for transmitting the first information in the embodiments of the present disclosure is introduced below.

In some implementations, the sidelink resource of the first information may be scheduled by a network device. That is, the above method further includes: transmitting, by the network device, first configuration information to the terminal device, the first configuration information being used for configuring the sidelink resource for transmitting the first information.

In some implementations, the above-mentioned first configuration information may be requested by the terminal device. That is, before the network device transmits the first configuration information to the terminal device, the above method further includes: transmitting, by the terminal device, a scheduling request to the network device, the scheduling request being used for requesting to schedule the sidelink resource for the first information.

In other implementations, the sidelink resource of the first information may also be determined autonomously by the terminal device. That is, the above method further includes: selecting, by the terminal device, the sidelink resource for transmitting the first information within a first time period. For example, the terminal device performs resource listening in the first time period, to select the sidelink resource for transmitting the first information.

In some implementations, a time-domain position of the first time period is determined based on one or more of: a time-domain position in which it is determined that the beam failure occurs; a time-domain position for the first indication information; a time-domain position of completing CSI-RS measurement; and a time-domain position of transmitting the first CSI-RS resource information.

In some implementations, the time-domain position in which the beam failure occurs is determined, where the time-domain position in which it is determined that the beam failure occurs may be a time-domain position in which the beam failure occurs that is determined by the transmitting end or a time-domain position in which the beam failure occurs that is determined by the receiving end.

In some implementations, the first indication information is used for indicating that the beam failure occurs, details may refer to the above introduction.

In some implementations, the CSI-RS measurement is used for selecting the second transmit beam, where the second transmit beam may refer to the above introduction.

In some implementations, the first CSI-RS resource information is used for selecting the second transmit beam. The introduction of the first CSI-RS resource information and/or the second transmit beam may refer to the above description.

In some implementations, the time-domain position of the first time period is determined based on one or more of the above-mentioned time-domain positions, which may include that the time-domain position of the first time period is a time-domain position obtained by taking the above-mentioned one or more time-domain positions as a time-domain start position and offsetting p time-domain resources, where the offsetting p may be determined based on one or more of: pre-configuration information; pre-defined information; and information configured by a network. In other implementations, the offsetting p may be associated with the subcarrier spacing.

For example, the receiving end determines that the time-domain position where the beam failure occurs is a slot n. Accordingly, the time-domain position of the first time period is a position obtained by taking the slot n as the time-domain start position and offsetting p slots, that is, the time-domain position of the first time period is a slot n+p.

In the embodiments of the present disclosure, the above-mentioned time-domain position of the first time period may be a time-domain start position of the first time period, or a time-domain end position of the first time period, or a time-domain center position of the first time period.

In some implementations, the time length of the first time period is determined based on one or more of: pre-configuration information; information configured by a network; and pre-defined information. Taking the example in which the time-domain position of the first time period is the time-domain start position, the first time period may be determined based on the time-domain start position and the length of the first time period.

In some implementations, the first information may be carried in SCI, and accordingly, the sidelink resource for transmitting the first information may include a resource available for transmitting a PSCCH.

In other implementations, the first information may be carried in an MAC CE, and accordingly, the sidelink resource for transmitting the first information may include a resource available for transmitting a PSSCH.

In some implementations, the above-mentioned step S610 includes: in response to meeting a first condition, receiving or transmitting, by the terminal device, the first information for the beam failure recovery through the first carrier.

In some implementations, the above-mentioned first condition includes one or more of the following conditions: determining that the beam failure occurs; a priority of data to be transmitted being greater than or equal to a threshold A; a remaining delay budget of the data to be transmitted being less than or equal to a threshold B; and a channel busy ratio (CBR) being less than or equal to a threshold C.

In the embodiments of the present disclosure, one or more thresholds of the above-mentioned threshold A, threshold B, and threshold C may be determined according to pre-configuration information or information configured by a network, or pre-defined by a protocol, or depend on an implementation of the terminal.

The method embodiments of the present disclosure are described in detail above with reference to FIG. 1 to FIG. 12, and apparatus embodiments of the present disclosure are described in detail below with reference to FIG. 13 to FIG. 15. It should be understood that the description of the method embodiments and the description of the apparatus embodiments correspond to each other, so the parts not described in detail may refer to the above method embodiments.

FIG. 13 is a schematic diagram of a terminal device in the embodiments of the present disclosure. The terminal device 1300 illustrated in FIG. 13 includes a communication unit 1310.

The communication unit 1310 is configured to receive or transmit first information for beam failure recovery through a first carrier, the first carrier being located in an FR1.

In some implementations, the first information carries one or more of: first indication information for indicating that beam failure occurs; second indication information for indicating a switch to a first transmit beam; information of the first transmit beam; CSI-RS resource configuration information for reselecting a transmit beam and/or a receive beam; first CSI-RS resource information, the first CSI-RS resource information being used for selecting a second transmit beam; a first measurement result corresponding to the first CSI-RS resource information; beam failure recovery information; and second CSI-RS resource information, the second CSI-RS resource information being used for indicating a selected second transmit beam.

In some implementations, in response to the first information carrying the second indication information, the first transmit beam is one of one or more candidate transmit beams.

In some implementations, in response to the first information carrying the information of the first transmit beam, the information of the first transmit beam includes CSI-RS resource information associated with the first transmit beam.

In some implementations, the information of the first transmit beam is used for indicating a switch to the first transmit beam.

In some implementations, in response to the first information carrying the CSI-RS resource configuration information, the CSI-RS resource configuration information is used for configuring one or more of: a time-domain resource position of a CSI-RS resource; a frequency-domain resource position of the CSI-RS resource; and a transmit beam associated with the CSI-RS resource.

In some implementations, in response to the CSI-RS resource configuration information being used for configuring the time-domain resource position of the CSI-RS resource, the time-domain resource position is periodically distributed or aperiodically distributed.

In some implementations, the CSI-RS resource configuration information is used for configuring one or more of: a time-domain offset of the CSI-RS resource; a period of the CSI-RS resource; a time-domain interval between two adjacent CSI-RS resources within each period; a number of time-domain resources capable of being occupied by the CSI-RS resource within each period; and a number of periodic transmissions of the CSI-RS resource.

In some implementations, the CSI-RS resource configuration information includes one or more of: a time-domain offset of the CSI-RS resource; a time-domain interval between two CSI-RS resources adjacent in time domain; and a number of time-domain resources capable of being occupied by the CSI-RS resource.

In some implementations, the CSI-RS resource configuration information being used for configuring the time-domain resource position of the CSI-RS resource includes: the CSI-RS resource configuration information being used for configuring a slot occupied by the CSI-RS resource.

In some implementations, in response to the CSI-RS resource configuration information being used for configuring the time-domain resource position of the CSI-RS resource, the CSI-RS resource configuration information is used for configuring a time-domain position of the CSI-RS resource in the slot.

In some implementations, the CSI-RS resource configuration information is used for configuring one of: a first OFDM symbol capable of being occupied by the CSI-RS resource in the slot; and a plurality of OFDM symbols capable of being occupied by the CSI-RS resource in the slot.

In some implementations, in response to the CSI-RS resource configuration information being used for configuring the frequency-domain resource position of the CSI-RS resource, the CSI-RS resource configuration information is used for configuring one or more of: a frequency-domain start position of the CSI-RS resource; a frequency-domain length capable of being occupied by the CSI-RS resource; a frequency-domain interval between two CSI-RS resources adjacent in frequency domain; and indication information of frequency-domain resources capable of being occupied by the CSI-RS resource.

In some implementations, in response to the CSI-RS resource configuration information being used for configuring a transmit beam associated with the CSI-RS resource, the CSI-RS resource configuration information includes one of a first parameter, a second parameter, and a third parameter; where the first parameter is used for indicating that transmit beams associated with the CSI-RS resource included in a period are same or different; the second parameter is used for indicating that transmit beams associated with the CSI-RS resource included in a time-domain unit are same or different; and the third parameter is used for indicating that transmit beams associated with the CSI-RS resource included in each period are same or different.

In some implementations, in response to the first information carrying the second CSI-RS resource information, the second CSI-RS resource information is used for indicating a beam recovery acknowledgement.

In some implementations, the first information is carried in one or more of: sidelink control information (SCI), an MAC CE, and PC5-RRC signaling.

In some implementations, the communication unit is configured to receive first configuration information transmitted from a network device, the first configuration information being used for configuring a sidelink resource for transmitting the first information.

In some implementations, the communication unit is configured to transmit a scheduling request, the scheduling request being used for requesting to schedule the sidelink resource for the first information.

In some implementations, the terminal device further includes: a processing unit, configured to select a sidelink resource for transmitting the first information within a first time period.

In some implementations, a time-domain start position of the first time period is determined based on one or more of: a time-domain position in which it is determined that beam failure occurs; a time-domain position of first indication information for indicating that beam failure occurs; a time-domain position of completing CSI-RS measurement, the CSI-RS measurement being used for selecting a second transmit beam; and a time-domain position of transmitting first CSI-RS resource information, the first CSI-RS resource information being used for selecting a second transmit beam.

In some implementations, a time length of the first time period is determined based on one or more of: pre-configuration information; information configured by a network; and pre-defined information.

FIG. 14 is a schematic diagram of a network device in the embodiments of the present disclosure. The network device 1400 illustrated in FIG. 14 may include: a transmitting unit 1410.

The transmitting unit 1410 is configured to transmit first configuration information to a terminal device, the first configuration information being used for configuring a sidelink resource for transmitting first information; where the first information is used for beam failure recovery, and a first carrier in which the sidelink resource of the first information is located is in an FR1.

In some implementations, a receiving unit is configured to receive a scheduling request transmitted from the terminal device, the scheduling request being used for requesting to schedule the sidelink resource for the first information.

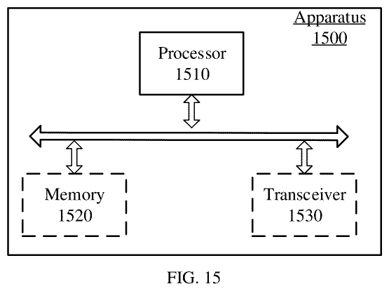

In optional embodiments, the communication unit 1310 may be a transceiver 1530. The terminal device 1300 may further include a processor 1510 and a memory 1520 as specifically illustrated in FIG. 15.

In optional embodiments, the transmitting unit 1410 may be a transceiver 1530. The network device 1400 may further include a processor 1510 and a memory 1420 as specifically illustrated in FIG. 15.

FIG. 15 is a schematic structural diagram of a communication apparatus of the embodiments of the present disclosure. Dashed lines in FIG. 15 indicate that the units or modules are optional. The apparatus 1500 may be used to implement the method described in the method embodiments described above. The apparatus 1500 may be a chip, a terminal device or a network device.

The apparatus 1500 may include one or more processors 1510. The processor 1510 may support the apparatus 1500 to implement the method described in the above method embodiments. The processor 1510 may be a general processor or a dedicated processor. For example, the processor may be a central processing unit (CPU). Or, the processor may also be other general processors, digital signal processor (DSP), application specific integrated circuit (ASIC), field programmable gate array (FPGA), or other programmable logic devices, discrete gate or transistor logic devices, discrete hardware components, etc. The general processor may be a microprocessor, or the processor may be any conventional processor or the like.

The apparatus 1500 may also include one or more memories 1520. The memory 1520 stores a program, which may be performed by the processor 1510, so that the processor 1510 performs the method described in the above method embodiments. The memory 1520 may be independent of the processor 1510 or may be integrated into the processor 1510.

The apparatus 1500 may further include a transceiver 1530. The processor 1510 may communicate with other devices or chips via the transceiver 1530. For example, the processor 1510 may transmit and receive data with other devices or chips via the transceiver 1530.

The embodiments of the present disclosure also provide a non-transitory computer-readable storage medium configured to store a program. The non-transitory computer-readable storage medium may be applied to the terminal or the network device provided by the embodiments of the present disclosure, and the program causes a computer to perform the method performed by the terminal or the network device in various embodiments of the present disclosure.

The embodiments of the present disclosure also provide a computer program product. The computer program product includes a program. The computer program product may be applied to the terminal or the network device provided by the embodiments of the present disclosure, and the program causes a computer to perform the method performed by the terminal or the network device in various embodiments of the present disclosure.

The embodiments of the present disclosure also provide a computer program. The computer program may be applied to the terminal or the network device provided by the embodiments of the present disclosure, and the computer program causes a computer to perform the method performed by the terminal or the network device in various embodiments of the present disclosure.

It shall be understood that the terms “system” and “network” in the present disclosure may be used interchangeably. Furthermore, the terms used in the present disclosure are only used to explain the embodiments of the present disclosure, but are not intended to limit the present disclosure. The terms “first”, “second”, “third”, “fourth” and the like in the specification, claims and drawings of the present disclosure are used to distinguish different objects, rather than to describe a specific order. In addition, the terms “include/comprise” and “has/have” and any variations thereof, are intended to cover the non-exclusive inclusion.

In the embodiments of the present disclosure, the “indicate/indicated/indicating/indication” mentioned may be a direct indication, an indirect indication, or may also indicate that there is an associated relationship. For example, A indicating B may mean that A directly indicates B, for example, B may be obtained by A; alternatively, A indicating B may mean that A indirectly indicates B, for example, A indicates C, and B may be obtained by C; alternatively, A indicating B may mean that there is an associated relationship between A and B.

In the embodiments of the present disclosure, “B corresponding to A” means that B is associated with A, and B may be determined according to A. However, it shall also be understood that determining B according to A does not mean determining B based on A only, and B may also be determined based on A and/or other information.

In the embodiments of the present disclosure, the term “correspond/corresponding/correspondence” may indicate a direct correspondence or an indirect correspondence between two items, or may mean that there is an associated relationship between the two items, or may mean a relationship of indicating and being indicated, or a relationship of configuring and being configured, or the like.

In the embodiments of the present disclosure, the “predefined” or “pre-configured” and variations thereof may be implemented by pre-saving corresponding codes, tables or other manners that may be used to indicate related information, in the device (for example, including the terminal device and the network device), and the present disclosure does not limit its specific implementation. For example, the predefined may refer to what is defined in a protocol.

In the embodiments of the present disclosure, the term “protocol” may refer to a standard protocol in the field of communications, and for example, the “protocol” may include an LTE protocol, an NR protocol, and a related protocol used in a future communication system, which is not limited in the present disclosure.

In the embodiments of the present disclosure, the term “and/or” herein is only an association relationship to describe associated objects, indicating that there may be three kinds of relationships, and for example, “A and/or B” may represent three cases where: A exists alone, both A and B exist, and B exist alone. In addition, a character “/” herein generally indicates that the associated objects before and after this character are in an “or” relationship.

In various embodiments of the present disclosure, values of serial numbers of the aforementioned processes do not mean an execution order, and the execution order of each process shall be determined by its function and internal logic, and shall not impose any limitation on the implementation process of the embodiments of the present disclosure.

It shall be understood that the disclosed systems, apparatuses, and methods in several embodiments provided in the present disclosure may be implemented in other modes. For example, the apparatus embodiments described above are merely exemplary, and for example, a division of units is merely a division based on logical functions, while other divisions exist in actual implementations. For example, a plurality of units or components may be combined or integrated into another system, or some features may be omitted or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

All or part of the above embodiments may be implemented by software, hardware, firmware or any combination thereof. When implemented by using software, all or part of the embodiments may be implemented in a form of a computer program product. The computer program product includes one or more computer instructions. When the computer program instructions are loaded and executed on a computer, all or part of the procedures or functions described according to the embodiments of the present disclosure are generated. The computer may be a general-purpose computer, a dedicated-purpose computer, a computer network, or other programmable apparatus. The computer instructions may be stored in a non-transitory computer-readable storage medium, or transmitted from a non-transitory computer-readable storage medium to another non-transitory computer-readable storage medium. For example, the computer instructions may be transmitted from a website, a computer, a server, or a data center to another website, another computer, another server, or another data center via a wired mode (e.g., a coaxial cable, optical fiber, a digital subscriber line (DSL)) or a wireless mode (e.g., an infrared, radio, microwave, etc.). The non-transitory computer-readable storage medium may be any available medium that can be read by a computer, or a data storage device including a server or a data center integrated with one or more available media, etc. The available medium may be a magnetic medium (e.g., a floppy disk, a hard disk, a magnetic tape), an optical medium (e.g., a digital video disc (DVD)), or a semiconductor medium (e.g., a solid state disk (SSD)), etc.

The above content is only implementations of the present disclosure, but the protection scope of the present disclosure is not limited thereto, and any skilled familiar with this technical field may easily think of changes or substitutions within the technical scope disclosed in the present disclosure, which shall be all covered within the protection scope of the present disclosure. Therefore, the protection scope of the present disclosure should be determined based on the protection scope of the claims.

What is claimed is:

1. A wireless communication method, comprising:
receiving or transmitting, by a terminal device, first information for beam failure recovery through a first carrier, the first carrier being located in a frequency range (FR) 1.

2. The method according to claim 1, wherein the first information carries one or more of:
first indication information for indicating that beam failure occurs;
second indication information for indicating a switch to a first transmit beam;
information of the first transmit beam;
channel state information reference signal (CSI-RS) resource configuration information for reselecting a transmit beam and/or a receive beam;
first CSI-RS resource information, the first CSI-RS resource information being used for selecting a second transmit beam;
a first measurement result corresponding to the first CSI-RS resource information;
beam failure recovery information; and
second CSI-RS resource information, the second CSI-RS resource information being used for indicating a selected second transmit beam.

3. The method according to claim 2, wherein in response to the first information carrying the second indication information, the first transmit beam is one of one or more candidate transmit beams; or
in response to the first information carrying the information of the first transmit beam, the information of the first transmit beam comprises CSI-RS resource information associated with the first transmit beam, and the information of the first transmit beam is used for indicating a switch to the first transmit beam.

4. A terminal device, comprising a transceiver, a memory and a processor, wherein the memory is configured to store a computer program, and the computer program, when executed by the processor, enables the terminal device to perform:
receiving or transmitting first information for beam failure recovery through a first carrier, the first carrier being located in a frequency range (FR) 1.

5. The terminal device according to claim 4, wherein the first information carries one or more of:
first indication information for indicating that beam failure occurs;
second indication information for indicating a switch to a first transmit beam;
information of the first transmit beam;
channel state information reference signal (CSI-RS) resource configuration information for reselecting a transmit beam and/or a receive beam;
first CSI-RS resource information, the first CSI-RS resource information being used for selecting a second transmit beam;
a first measurement result corresponding to the first CSI-RS resource information;
beam failure recovery information; and
second CSI-RS resource information, the second CSI-RS resource information being used for indicating a selected second transmit beam.

6. The terminal device according to claim 5, wherein in response to the first information carrying the second indication information, the first transmit beam is one of one or more candidate transmit beams; or
in response to the first information carrying the information of the first transmit beam, the information of the first transmit beam comprises CSI-RS resource information associated with the first transmit beam, and the information of the first transmit beam is used for indicating a switch to the first transmit beam.

7. The terminal device according to claim 5, wherein in response to the first information carrying the CSI-RS resource configuration information, the CSI-RS resource configuration information is used for configuring one or more of:
a time-domain resource position of a CSI-RS resource;
a frequency-domain resource position of the CSI-RS resource; and
a transmit beam associated with the CSI-RS resource.

8. The terminal device according to claim 7, wherein in response to the CSI-RS resource configuration information being used for configuring the time-domain resource position of the CSI-RS resource, the time-domain resource position is periodically distributed or aperiodically distributed.

9. The terminal device according to claim 8, wherein the CSI-RS resource configuration information is used for configuring one or more of:
a time-domain offset of the CSI-RS resource;
a period of the CSI-RS resource;
a time-domain interval between two adjacent CSI-RS resources within each period;
a number of time-domain resources capable of being occupied by the CSI-RS resource within each period; and
a number of periodic transmissions of the CSI-RS resource.

10. The terminal device according to claim 8, wherein the CSI-RS resource configuration information includes one or more of:
a time-domain offset of the CSI-RS resource;
a time-domain interval between two CSI-RS resources adjacent in time domain; and
a number of time-domain resources capable of being occupied by the CSI-RS resource.

11. The terminal device according to claim 7, wherein the CSI-RS resource configuration information being used for configuring the time-domain resource position of the CSI-RS resource comprises: the CSI-RS resource configuration information being used for configuring a slot occupied by the CSI-RS resource.

12. The terminal device according to claim 11, wherein in response to the CSI-RS resource configuration information being used for configuring the time-domain resource position of the CSI-RS resource, the CSI-RS resource configuration information is used for configuring a time-domain position of the CSI-RS resource in the slot;
wherein the CSI-RS resource configuration information is used for configuring one of:
a first orthogonal frequency division multiplexing (OFDM) symbol capable of being occupied by the CSI-RS resource in the slot; and
a plurality of OFDM symbols capable of being occupied by the CSI-RS resource in the slot.

13. The terminal device according to claim 7, wherein in response to the CSI-RS resource configuration information being used for configuring the frequency-domain resource position of the CSI-RS resource, the CSI-RS resource configuration information is used for configuring one or more of:
a frequency-domain start position of the CSI-RS resource;
a frequency-domain length capable of being occupied by the CSI-RS resource;
a frequency-domain interval between two CSI-RS resources adjacent in frequency domain; and
indication information of frequency-domain resources capable of being occupied by the CSI-RS resource.

14. The terminal device according to claim 7, wherein in response to the CSI-RS resource configuration information being used for configuring a transmit beam associated with the CSI-RS resource, the CSI-RS resource configuration information comprises one of a first parameter, a second parameter, and a third parameter; wherein
the first parameter is used for indicating that transmit beams associated with the CSI-RS resource comprised in a period are same or different; the second parameter is used for indicating that transmit beams associated with the CSI-RS resource comprised in a time-domain unit are same or different; and the third parameter is used for indicating that transmit beams associated with the CSI-RS resource comprised in each period are same or different.

15. The terminal device according to claim 4, wherein the computer program, when executed by the processor, enables the terminal device further to perform:
receiving first configuration information transmitted from a network device, the first configuration information being used for configuring a sidelink resource for transmitting the first information;
wherein before the terminal device receives the first configuration information transmitted from the network device, the computer program, when executed by the processor, enables the terminal device further to perform:
transmitting a scheduling request to the network device, the scheduling request being used for requesting to schedule the sidelink resource for the first information.

16. A network device, comprising a transceiver, a memory and a processor, wherein the memory is configured to store a computer program, and the computer program, when executed by the processor, enables the network device to perform:
transmitting first configuration information to a terminal device, the first configuration information being used for configuring a sidelink resource for transmitting first information;
wherein the first information is used for beam failure recovery, and a first carrier in which the sidelink resource of the first information is located is in a frequency range (FR) 1.

17. The network device according to claim 16, wherein before the network device transmits the first configuration information to the terminal device, the computer program, when executed by the processor, enables the network device further to perform:
receiving a scheduling request transmitted from the terminal device, the scheduling request being used for requesting to schedule the sidelink resource for the first information.

18. The network device according to claim 16, wherein the first information carries one or more of:
first indication information for indicating that beam failure occurs;
second indication information for indicating a switch to a first transmit beam;
information of the first transmit beam;
channel state information reference signal (CSI-RS) resource configuration information for reselecting a transmit beam and/or a receive beam;
first CSI-RS resource information, the first CSI-RS resource information being used for selecting a second transmit beam;
a first measurement result corresponding to the first CSI-RS resource information;
beam failure recovery information; and
second CSI-RS resource information, the second CSI-RS resource information being used for indicating a selected second transmit beam.

19. The network device according to claim 18, wherein in response to the first information carrying the second indication information, the first transmit beam is one of one or more candidate transmit beams; or
in response to the first information carrying the information of the first transmit beam, the information of the first transmit beam comprises CSI-RS resource information associated with the first transmit beam, and the information of the first transmit beam is used for indicating a switch to the first transmit beam.

20. The network device according to claim 18, wherein in response to the first information carrying the CSI-RS resource configuration information, the CSI-RS resource configuration information is used for configuring one or more of:
a time-domain resource position of a CSI-RS resource;
a frequency-domain resource position of the CSI-RS resource; and
a transmit beam associated with the CSI-RS resource.
